(19) United States
(12) Patent Application Publication
(10) Pub. No.: US 2025/0247133 A1
(43) Pub. Date: Jul. 31, 2025

(54) BACKWARDS COMPATIBLE ONE-SHOT INITIAL ACCESS

(71) Applicant: QUALCOMM INCORPORATED, San Diego, CA (US)

(72) Inventors: Saeid Sahraei, San Diego, CA (US); Wanshi Chen, San Diego, CA (US); Yu Zhang, San Diego, CA (US); Peter Gaal, San Diego, CA (US); Hung Dinh Ly, San Diego, CA (US); Krishna Kiran Mukkavilli, San Diego, CA (US)

(21) Appl. No.: 18/702,873

(22) PCT Filed: Dec. 7, 2021
(86) PCT No.: PCT/CN2021/135947

§ 371 Date: Apr. 19, 2024

(51) Int. Cl. H04B 7/04; H04B 7/06; H04L 5/00; H04W 74/0833

(52) U.S. Cl. CPC H04B 7/04013; H04B 7/06952; H04L 5/0005; H04W 74/0833

(57) ABSTRACT

Methods, systems, and devices for wireless communication are described. A user equipment (UE) may monitor a plurality of synchronization raster frequencies to identify a frequency of a downlink signal transmitted from a base station, a first subset of the plurality of synchronization raster frequencies corresponding to the UE receiving the downlink signal from the base station and a second subset of the plurality of synchronization raster frequencies corresponding to the UE receiving the downlink signal from the base station via a configurable reflective device. The UE may identify a raster index associated with the frequency, the raster index corresponding to one of receiving the downlink signal from the base station or receiving the downlink signal from the base station via the configurable reflective device. The UE may transmit an uplink signal to the base station indicating the raster index.

### CROSS REFERENCE

The present Application is a 371 national stage filing of International PCT Application No. PCT/CN2021/135947 by Sahraei et al. entitled “BACKWARDS COMPATIBLE ONE-SHOT INITIAL ACCESS,” filed Dec. 7, 2021, which is assigned to the assignee hereof, and which is expressly incorporated by reference in its entirety herein.

### FIELD OF TECHNOLOGY

The following relates to wireless communication, including backwards compatible one-shot initial access.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support backwards compatible one-shot initial access. Generally, the described techniques provide for defining a synchronization raster based at least in part on a function of the number of reconfigurable intelligent surface (RIS) beams, where a user equipment (UE) indicates a raster index in its uplink reporting. The reported raster index may inform a base station whether the UE received a signal directly from the base station, or indirectly via the RIS. The raster center frequencies of the newly defined synchronization raster may be a multiple of the conventional 1.44 MHz synchronization offset raster frequencies and the number of subpanels. This may result in the raster frequencies of the synchronization raster being detectable by legacy UE and advanced UE to detect the watermarked (e.g., at the 1.44 MHz offset) signals reflected by different subpanels of the RIS. The UE may report the raster index corresponding to the frequency and report this to the base station. The indication of the raster index may provide an indication of which RIS beam (e.g., and corresponding RIS subpanel was used to generate the RIS beam) that the UE detected the signal on. The base station may use the raster index to determine whether the UE is directly or indirectly receiving signals from the base station, and may configure communication with the UE accordingly.

A method for wireless communication at a UE is described. The method may include monitoring a set of multiple synchronization raster frequencies to identify a frequency of a downlink signal transmitted from a base station, a first subset of the set of multiple synchronization raster frequencies corresponding to the UE receiving the downlink signal from the base station and a second subset of the set of multiple synchronization raster frequencies corresponding to the UE receiving the downlink signal from the base station via a configurable reflective device, identifying a raster index associated with the frequency, the raster index corresponding to one of receiving the downlink signal from the base station or receiving the downlink signal from the base station via the configurable reflective device, and transmitting an uplink signal to the base station indicating the raster index.

An apparatus for wireless communication at a UE is described. The apparatus may include a processor, memory coupled with the processor, and instructions stored in the memory. The instructions may be executable by the processor to cause the apparatus to monitor a set of multiple synchronization raster frequencies to identify a frequency of a downlink signal transmitted from a base station, a first subset of the set of multiple synchronization raster frequencies corresponding to the UE receiving the downlink signal from the base station and a second subset of the set of multiple synchronization raster frequencies corresponding to the UE receiving the downlink signal from the base station via a configurable reflective device, identify a raster index associated with the frequency, the raster index corresponding to one of receiving the downlink signal from the base station or receiving the downlink signal from the base station via the configurable reflective device, and transmit an uplink signal to the base station indicating the raster index.

Another apparatus for wireless communication at a UE is described. The apparatus may include means for monitoring a set of multiple synchronization raster frequencies to identify a frequency of a downlink signal transmitted from a base station, a first subset of the set of multiple synchronization raster frequencies corresponding to the UE receiving the downlink signal from the base station and a second subset of the set of multiple synchronization raster frequencies corresponding to the UE receiving the downlink signal from the base station via a configurable reflective device, means for identifying a raster index associated with the frequency, the raster index corresponding to one of receiving the downlink signal from the base station or receiving the downlink signal from the base station via the configurable reflective device, and means for transmitting an uplink signal to the base station indicating the raster index.

A non-transitory computer-readable medium storing code for wireless communication at a UE is described. The code may include instructions executable by a processor to monitor a set of multiple synchronization raster frequencies to identify a frequency of a downlink signal transmitted from a base station, a first subset of the set of multiple synchronization raster frequencies corresponding to the UE receiving the downlink signal from the base station and a second subset of the set of multiple synchronization raster frequencies corresponding to the UE receiving the downlink signal from the base station via a configurable reflective device, identify a raster index associated with the frequency, the raster index corresponding to one of receiving the downlink signal from the base station or receiving the downlink signal from the base station via the configurable reflective device, and transmit an uplink signal to the base station indicating the raster index.

Some examples of the method, apparatuses, and non-transitory computer-readable medium described herein may further include operations, features, means, or instructions for identifying a random access configuration corresponding to the raster index to use during a random access procedure with the base station and transmitting one or more random access messages according to the random access configuration.

In some examples of the method, apparatuses, and non-transitory computer-readable medium described herein, transmitting the one or more random access messages may include operations, features, means, or instructions for transmitting the one or more random access messages during a random access occasion selected from a set of multiple available random access occasions, where the random access configuration indicates the random access occasion corresponding to the raster index.

In some examples of the method, apparatuses, and non-transitory computer-readable medium described herein, transmitting the one or more random access messages may include operations, features, means, or instructions for transmitting the one or more random access messages including a random access preamble selected from a set of multiple available random access preambles, where the random access configuration indicates the random access preamble corresponding to the raster index.

Some examples of the method, apparatuses, and non-transitory computer-readable medium described herein may further include operations, features, means, or instructions for transmitting, based on the monitoring, the uplink signal indicating the raster index in a frequency domain and a beam index in a time domain corresponding to the downlink signal.

Some examples of the method, apparatuses, and non-transitory computer-readable medium described herein may further include operations, features, means, or instructions for identifying a beam index associated with the downlink signal transmitted from the base station, where the beam index may be based on the raster index and the uplink signal indicates the beam index.

In some examples of the method, apparatuses, and non-transitory computer-readable medium described herein, the first subset of the set of multiple synchronization raster frequencies may be associated with a network configured synchronization raster and the second subset of the set of multiple synchronization raster frequencies include offset frequencies relative to a default network configured synchronization raster.

A method for wireless communication at a base station is described. The method may include transmitting a downlink signal to a UE via a first frequency of a first subset of a set of multiple synchronization raster frequencies, receiving an uplink signal from the UE indicating a raster index, the raster index associated with a frequency of the downlink signal identified by the UE, the raster index corresponding to the UE one of receiving the downlink signal from the base station via the first frequency or receiving the downlink signal from the base station via a second frequency of a second subset of the set of multiple synchronization raster frequencies corresponding to the UE receiving the downlink signal from the base station via a configurable reflective device, and communicating with the UE based on the raster index indicated in the uplink signal.

An apparatus for wireless communication at a base station is described. The apparatus may include a processor, memory coupled with the processor, and instructions stored in the memory. The instructions may be executable by the processor to cause the apparatus to transmit a downlink signal to a UE via a first frequency of a first subset of a set of multiple synchronization raster frequencies, receive an uplink signal from the UE indicating a raster index, the raster index associated with a frequency of the downlink signal identified by the UE, the raster index corresponding to the UE one of receiving the downlink signal from the base station via the first frequency or receiving the downlink signal from the base station via a second frequency of a second subset of the set of multiple synchronization raster frequencies corresponding to the UE receiving the downlink signal from the base station via a configurable reflective device, and communicate with the UE based on the raster index indicated in the uplink signal.

Another apparatus for wireless communication at a base station is described. The apparatus may include means for transmitting a downlink signal to a UE via a first frequency of a first subset of a set of multiple synchronization raster frequencies, means for receiving an uplink signal from the UE indicating a raster index, the raster index associated with a frequency of the downlink signal identified by the UE, the raster index corresponding to the UE one of receiving the downlink signal from the base station via the first frequency or receiving the downlink signal from the base station via a second frequency of a second subset of the set of multiple synchronization raster frequencies corresponding to the UE receiving the downlink signal from the base station via a configurable reflective device, and means for communicating with the UE based on the raster index indicated in the uplink signal.

A non-transitory computer-readable medium storing code for wireless communication at a base station is described. The code may include instructions executable by a processor to transmit a downlink signal to a UE via a first frequency of a first subset of a set of multiple synchronization raster frequencies, receive an uplink signal from the UE indicating a raster index, the raster index associated with a frequency of the downlink signal identified by the UE, the raster index corresponding to the UE one of receiving the downlink signal from the base station via the first frequency or receiving the downlink signal from the base station via a second frequency of a second subset of the set of multiple synchronization raster frequencies corresponding to the UE receiving the downlink signal from the base station via a configurable reflective device, and communicate with the UE based on the raster index indicated in the uplink signal.

Some examples of the method, apparatuses, and non-transitory computer-readable medium described herein may further include operations, features, means, or instructions for identifying, based on the raster index, a configurable subpanel of a set of configurable subpanels of the configurable reflective device used to reflect the downlink signal from the base station to the UE.

In some examples of the method, apparatuses, and non-transitory computer-readable medium described herein, each configurable subpanel of the set of configurable subpanels may be associated with a respective frequency and each frequency of the respective frequencies may be associated with a respective raster index.

Some examples of the method, apparatuses, and non-transitory computer-readable medium described herein may further include operations, features, means, or instructions for receiving one or more random access messages from the UE according to a random access configuration, the random access configuration corresponding to the raster index.

In some examples of the method, apparatuses, and non-transitory computer-readable medium described herein, receiving the one or more random access messages may include operations, features, means, or instructions for receiving the one or more random access messages during a random access occasion selected from a set of multiple available random access occasions, where the random access configuration indicates the random access occasion corresponding to the raster index.

In some examples of the method, apparatuses, and non-transitory computer-readable medium described herein, receiving the one or more random access messages may include operations, features, means, or instructions for receiving the one or more random access messages including a random access preamble selected from a set of multiple available random access preambles, where the random access configuration indicates the random access preamble corresponding to the raster index.

Some examples of the method, apparatuses, and non-transitory computer-readable medium described herein may further include operations, features, means, or instructions for receiving the uplink signal indicating the raster index in a frequency domain and a beam index in a time domain corresponding to the downlink signal.

Some examples of the method, apparatuses, and non-transitory computer-readable medium described herein may further include operations, features, means, or instructions for identifying, based on the raster index, a beam index associated with the downlink signal, where the beam index corresponds to the raster index and the uplink signal indicates the beam index.

In some examples of the method, apparatuses, and non-transitory computer-readable medium described herein, the raster index associated with the frequency may be from a synchronization raster associated with the configurable reflective device and the synchronization raster includes a set of raster indices that may be based on a number of configurable subpanels of the configurable reflective device.

A method for wireless communication at a configurable reflective device is described. The method may include receiving, from a base station, a downlink signal at a frequency from a first subset of a set of multiple synchronization raster frequencies, receiving, from the base station, control signaling indicating to configure each configurable subpanel of a set of configurable subpanels of the configurable reflective device to reflect the downlink signal to a UE at a respective synchronization raster frequency from a second subset of the set of multiple synchronization raster frequencies, and receiving an uplink signal from the UE indicating a raster index corresponding to one of the respective synchronization raster frequencies from the first subset or the second subset of the set of multiple synchronization raster frequencies.

An apparatus for wireless communication at a configurable reflective device is described. The apparatus may include a processor, memory coupled with the processor, and instructions stored in the memory. The instructions may be executable by the processor to cause the apparatus to receive, from a base station, a downlink signal at a frequency from a first subset of a set of multiple synchronization raster frequencies, receive, from the base station, control signaling indicating to configure each configurable subpanel of a set of configurable subpanels of the configurable reflective device to reflect the downlink signal to a UE at a respective synchronization raster frequency from a second subset of the set of multiple synchronization raster frequencies, and receive an uplink signal from the UE indicating a raster index corresponding to one of the respective synchronization raster frequencies from the first subset or the second subset of the set of multiple synchronization raster frequencies.

Another apparatus for wireless communication at a configurable reflective device is described. The apparatus may include means for receiving, from a base station, a downlink signal at a frequency from a first subset of a set of multiple synchronization raster frequencies, means for receiving, from the base station, control signaling indicating to configure each configurable subpanel of a set of configurable subpanels of the configurable reflective device to reflect the downlink signal to a UE at a respective synchronization raster frequency from a second subset of the set of multiple synchronization raster frequencies, and means for receiving an uplink signal from the UE indicating a raster index corresponding to one of the respective synchronization raster frequencies from the first subset or the second subset of the set of multiple synchronization raster frequencies.

A non-transitory computer-readable medium storing code for wireless communication at a configurable reflective device is described. The code may include instructions executable by a processor to receive, from a base station, a downlink signal at a frequency from a first subset of a set of multiple synchronization raster frequencies, receive, from the base station, control signaling indicating to configure each configurable subpanel of a set of configurable subpanels of the configurable reflective device to reflect the downlink signal to a UE at a respective synchronization raster frequency from a second subset of the set of multiple synchronization raster frequencies, and receive an uplink signal from the UE indicating a raster index corresponding to one of the respective synchronization raster frequencies from the first subset or the second subset of the set of multiple synchronization raster frequencies.

Some examples of the method, apparatuses, and non-transitory computer-readable medium described herein may further include operations, features, means, or instructions for reflecting the uplink signal from the UE to the base station via at least one configurable subpanel of the set of configurable subpanels.

### BRIEF DESCRIPTION OF THE DRAWINGS

FIG. 1 illustrates an example of a wireless communications system that supports backwards compatible one-shot initial access in accordance with aspects of the present disclosure.

FIG. 2 illustrates an example of a wireless communication system that supports backwards compatible one-shot initial access in accordance with aspects of the present disclosure.

FIG. 3 illustrates an example of a wireless communication system that supports backwards compatible one-shot initial access in accordance with aspects of the present disclosure.

FIG. 4 illustrates an example of a raster configuration that supports backwards compatible one-shot initial access in accordance with aspects of the present disclosure.

FIG. 5 illustrates an example of a process that supports backwards compatible one-shot initial access in accordance with aspects of the present disclosure.

FIGS. 6 and 7 show block diagrams of devices that support backwards compatible one-shot initial access in accordance with aspects of the present disclosure.

FIG. 8 shows a block diagram of a communications manager that supports backwards compatible one-shot initial access in accordance with aspects of the present disclosure.

FIG. 9 shows a diagram of a system including a device that supports backwards compatible one-shot initial access in accordance with aspects of the present disclosure.

FIGS. 10 and 11 show block diagrams of devices that support backwards compatible one-shot initial access in accordance with aspects of the present disclosure.

FIG. 12 shows a block diagram of a communications manager that supports backwards compatible one-shot initial access in accordance with aspects of the present disclosure.

FIG. 13 shows a diagram of a system including a device that supports backwards compatible one-shot initial access in accordance with aspects of the present disclosure.

FIGS. 14 through 18 show flowcharts illustrating methods that support backwards compatible one-shot initial access in accordance with aspects of the present disclosure.

### DETAILED DESCRIPTION

Wireless networks may include one or more configurable reflective devices deployed within the network, which may also be referred to as reconfigurable intelligent surfaces (RIS). These RIS may be passive devices having configurable, reflective surfaces (e.g., subpanels). The RIS may be capable of receiving configuration messages from an associated base station including instructions to reconfigure subpanel(s) of the RIS in order to reflect a transmitted signal according to a configuration that slightly shifts the center frequency (e.g., watermarking based on the Doppler effect) of the signal and reflects the signal in a specific direction. While some advanced user equipment (UE) may be capable of monitoring the center frequency as well as the shifted frequencies (e.g., watermarked signal), legacy UE may not be capable of monitoring (or even aware of) the watermarked signals.

Generally, the described techniques provide for defining a synchronization raster based at least in part on a function of the number of RIS beams, where a UE indicates a raster index in its uplink reporting. The reported raster index may inform a base station whether the UE received a signal directly from the base station, or indirectly via the RIS. The raster center frequencies of the newly defined synchronization raster may be a multiple of the conventional 1.44 MHz synchronization offset raster frequencies and the number of subpanels. This may result in the raster frequencies of the synchronization raster being detectable by legacy UE and advanced UE to detect the watermarked (e.g., at the 1.44 MHz offset) signals reflected by different subpanels of the RIS. The UE may report the raster index corresponding to the frequency and report this to the base station. The indication of the raster index may provide an indication of which RIS beam (e.g., and corresponding RIS subpanel was used to generate the RIS beam) that the UE detected the signal on. The base station may use the raster index to determine whether the UE is directly or indirectly receiving signals from the base station, and may configure communication with the UE accordingly.

Aspects of the disclosure are initially described in the context of wireless communications systems. Aspects of the disclosure are further illustrated by and described with reference to apparatus diagrams, system diagrams, and flowcharts that relate to backwards compatible one-shot initial access.

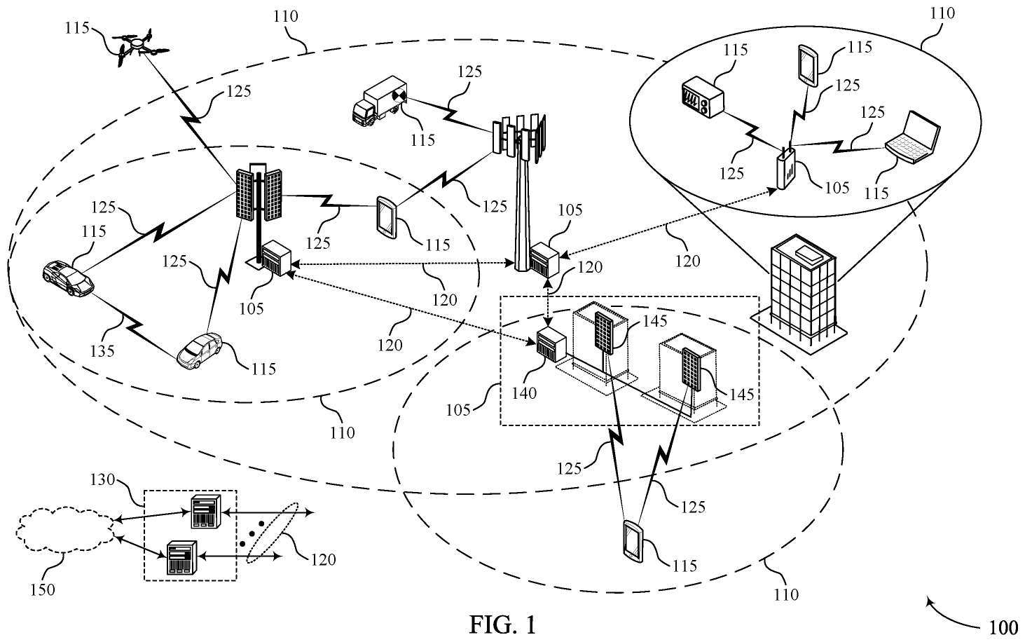

FIG. 1 illustrates an example of a wireless communications system 100 that supports backwards compatible one-shot initial access in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may monitor a plurality of synchronization raster frequencies to identify a frequency of a downlink signal transmitted from a base station 105, a first subset of the plurality of synchronization raster frequencies corresponding to the UE 115 receiving the downlink signal from the base station 105 and a second subset of the plurality of synchronization raster frequencies corresponding to the UE 115 receiving the downlink signal from the base station 105 via a configurable reflective device. The UE 115 may identify a raster index associated with the frequency, the raster index corresponding to one of receiving the downlink signal from the base station 105 or receiving the downlink signal from the base station 105 via the configurable reflective device. The UE 115 may transmit an uplink signal to the base station 105 indicating the raster index.

A base station 105 may transmit a downlink signal to a UE 115 via a first frequency of a first subset of a plurality of synchronization raster frequencies. The base station 105 may receive an uplink signal from the UE 115 indicating a raster index, the raster index associated with a frequency of the downlink signal identified by the UE 115, the raster index corresponding to the UE 115 one of receiving the downlink signal from the base station 105 via the first frequency or receiving the downlink signal from the base station 105 via a second frequency of a second subset of the plurality of synchronization raster frequencies corresponding to the UE 115 receiving the downlink signal from the base station 105 via a configurable reflective device. The base station 105 may communicate with the UE 115 based at least in part on the raster index indicated in the uplink signal.

A configurable reflective device (which may be may receiving, from a base station 105, a downlink signal at a frequency from a first subset of a plurality of synchronization raster frequencies. The configurable reflective device may receive, from the base station 105, control signaling indicating to configure each configurable subpanel of a set of configurable subpanels of the configurable reflective device to reflect the downlink signal to a UE 115 at a respective synchronization raster frequency from a second subset of the plurality of synchronization raster frequencies. The configurable reflective device may receive an uplink signal from the UE 115 indicating a raster index corresponding to one of the respective synchronization raster frequencies from the first subset or the second subset of the plurality of synchronization raster frequencies.

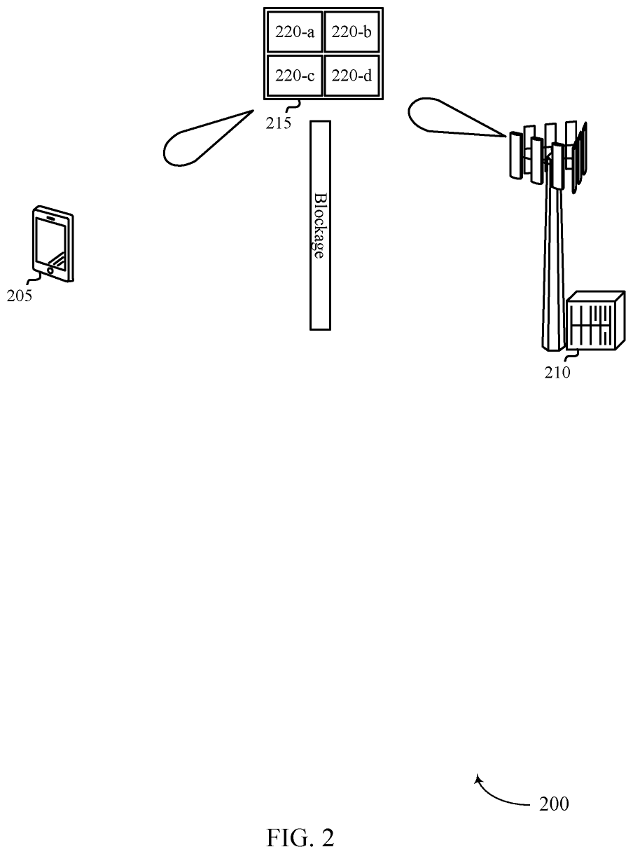

FIG. 2 illustrates an example of a wireless communication system 200 that supports backwards compatible one-shot initial access in accordance with aspects of the present disclosure. Wireless communication system 200 may include UE 205, base station 210, and a configurable reflective device 215, which may be examples of the corresponding devices described herein. Configurable reflective device 215 may include a set of configurable subpanels 220, with four configuration subpanels 220 being shown by way of example only.

Wireless communication system 200 may support massive MIMO techniques to support increases in throughput. This may include high beamforming gains using active antenna units. This may include configuring individual radio frequency (RF) chains per antenna port. However, this approach may be associated with a significant increase in power consumption due to the use of the active antenna units (AAU).

Additionally, or alternatively, wireless communication system 200 may include configurable reflective device 215, which may also be referred to as a RIS. Configurable reflective device 215 may be employed within a wireless network to extend coverage (e.g., around a blockage), with negligible power consumption. Configurable reflective device 215 may be a near passive device including the configurable subpanels 220. Each, some, or all configurable subpanels 220 may generally be configured to reflect an impinging wave to a desired direction. Configurable reflective device 215 may include a receiver enabling base station 210 to control the reflection direction of each configurable subpanels 220. For example, base station 210 may transmit control signaling to configurable reflective device 215 indicating how each configurable subpanels 220 is to be configured.

That is, devices such as UE 205 and base station 210 may leverage established communication links with configurable reflective device 215 that is coupled with or otherwise able to control the configuration of the reflective surface (e.g., configurable subpanels 220) to establish a communication link between the devices via the reflective surface. For example, configurable reflective device 215 may establish a communication link with each of two devices via respective beam training procedures and configurable reflective device 215 may use information, such as beam directions or other characteristics, associated with directional beams that configurable reflective device 215 uses for communication with the two devices, as well as information associated with which of the two devices is transmitting to the other, to control a reflection characteristic of the reflective surface. In other words, configurable reflective device 215 may use information associated with a direction of signaling, such as a direction of signal reception (such as a receive beam direction) and/or a direction of signal transmission (such as a transmit beam direction) to determine or otherwise infer a direction of incident signaling at the reflective surface and a direction for reflected signaling from the reflective surface. Configurable reflective device 215 accordingly may control the reflection characteristic of the reflective surface in accordance with the determined or inferred directions of incident and reflected signaling.

In some examples, configurable reflective device 215 may be used for initial access procedures (e.g., for transparent multi-beam initial access for RIS). With beam-planning between base station 210 and configurable reflective device 215, the legacy initial access (e.g., random access channel (RACH) procedure) may be modified to accommodate RIS beam sweeping. Generally, this may include base station 210 beam sweeping synchronization signal block (SSB) transmissions in a circular fashion within its respective coverage area. Each SSB transmission may be performed on a respective SSB beam and convey information used by UEs (such as UE 205) for initial access. In the initial access scenario involving configurable reflective device 215 the base station 210 may repeat transmitting a subset of the SSB beams (e.g., those beams that would otherwise be obstructed by a blockage) towards the RIS, which allows configurable reflective device 215 to perform its own beam sweeping. UE 205 may respond indicating the strongest beam (e.g., a strongest reference signal receive power (RSRP) of the reflected SSB beams. Base station 210 may configure its beams (e.g., transmit and receive) as well as the RIS's beams based on the feedback. This process is generally transparent to UE 205 (e.g., UE 205 may be unaware of when the SSB beams are received directly from base station 210 or are reflected by configurable reflective device 215).

However, this transparent approach is associated with at least some shortcomings. In order to cover a certain field of view, base station 210 may use wider beams for the SSB transmission. This may be due to several beams being transmitted in the same direction (e.g., towards configurable reflective device 215 when the subset of SSB beams are repeated). Using wider SSB beam means UEs will receive a weaker signal, which may reduce the coverage of the beams. Configuring the wider beams may also be challenging at base station 210. Moreover, it is impossible using this approach for base station 210 to tell whether the UE has received the direct signal from base station 210 or the reflected signal from the RIS. For instance, if UE 205 were to report a given SSB beam as the strongest, it is not clear whether the UE received the direct beam from base station 210 or the reflected beam from the RIS. This information helps base station 210 to configure the RIS to serve a UE only when needed. If at any point RIS is blocked by an object, the modified beam-sweeping becomes inefficient as the subset of the SSB beams are transmitted in a blocked direction. Accordingly, this approach is generally not a scalable solution and may not be able accommodate multiple RIS.

One approach to address this is to introduce watermarking of the reflected signal to differentiate between SSB beams reflected by configurable reflective device 215. In particular, by slowly changing the configuration of the RIS over time, the reflected signal (e.g., SSB transmission) may be shifted in the frequency domain (e.g., watermarked). That is, one drawback of the transparent approach is that base station 210 cannot tell if the UE is connected to base station 210 directly or via configurable reflective device 215. Watermarking the reflected signal may be used to attempt to distinguish the base station SSB beams from the RIS reflected SSB beams. As base station 210 transmits SSB beams towards configurable reflective device 215, the configurable reflective device 215 adds the watermarking to the SSB transmissions it reflects. In some examples, each configurable subpanel 220 may be configurable to apply a separate watermarking. Such watermarking may generally shift or otherwise change the center frequency of the SSB beam(s) being reflected from configurable reflective device 215.

This may result in a new synchronization raster being defined specific to configurable reflective device 215. For example, while conventional techniques apply a synchronization raster having synchronization signal center frequency based on 2400 MHz+N*1.44 MHz, a new raster may be defined for configurable reflective device 215 based on such watermarking. For example, some watermarking approaches introduce a 0.36 MHz shift in the frequency domain resulting from the Doppler effect. This may result in a raster of 2400.36 MHz+N*1.44 MHz or 2399.64 MHz+N*1.44 MHz (which is not generally supported within wireless communication system 200). For example, this watermarking would require a UE to monitor both rasters (e.g., the synchronization raster as well as the RIS raster) to find the strongest beam and report both the strongest beam in the time domain and the synchronization raster in the frequency domain, which again is not currently supported according to conventional techniques.

More particularly, in some examples of the one-shot initial access involving RIS base station 210 may repeat an SSB beam transmission to configurable reflective device 215 and configurable reflective device 215 may reflect the SSB beam from each configurable subpanels 220. Each configurable subpanels 220 may watermark (e.g., shift the center frequency) its reflected SSB beam towards UE 205. For example, configurable subpanels 220-a may introduce a frequency shift 0 (FS_0) reflected in the direction of RIS beam 0, configurable subpanels 220-b may introduce a frequency shift 1 (FS_1) reflected in the direction of RIS beam 1, configurable subpanels 220-c may introduce a frequency shift 2 (FS_2) reflected in the direction of RIS beam 2, and configurable subpanels 220-d may introduce a frequency shift 3 (FS_3) reflected in the direction of RIS beam 3. This would require UE 205 to monitor for all four frequencies (e.g., rasters) in both the time domain and frequency domain.

One issue with this approach is that the synchronization raster is shifted to a different frequency that is not monitored by the legacy UEs. Therefore, legacy UEs are unable to benefit from the RIS deployment. To resolve this issue, one approach to resolve this is to define the watermarking frequency shift in such a way that it maps the synchronization raster onto itself. As discussed, the synchronization raster is generally given by 2400 MHz+N*1.44 MHz. Therefore, the watermarking frequency shift may be defined to be a multiple of 1.44 MHz. In this approach, the legacy UE may monitor the legacy raster and report the strongest beam. Unfortunately, with this choice of frequency shift (e.g., using multiples of 1.44 MHz as the watermarking frequency shift), it is impossible for a new or advanced (as opposed to legacy) UE to tell if the SSB is received over the legacy raster or the shifted raster by the RIS.

Accordingly, aspects of the techniques described herein provide for base station 210 to decimate (e.g., redefine) its synchronization raster. For instance, the raster center frequency can be changed to 2400 MHz+N*5.76 MHz to accommodate four RIS beams. Redefining the raster may not impact the legacy UE, but new or advanced UE can now distinguish between the beams received over the legacy raster or any of the shifted rasters (e.g., RIS beams). More broadly, this may include changing the synchronization raster from 2400 MHz+N*1.44 MHz to 2400 MHz+N*y*1.44 MHz, where y is the number of RIS beams to accommodate (e.g., which may correspond to the number of configurable subpanels 220 in some examples).

For example, base station 210 may transmit or otherwise provide a downlink signal (e.g., an SSB signal via a corresponding SSB beam) to UE 205. The downlink signal may be transmitted using a first frequency of a first subset of a plurality of synchronization raster frequencies. The RIS (e.g., configurable reflective device 215) may receive the downlink signal at the first frequency. Base station 210 may also transmit or otherwise provide a signal (e.g., a control signaling) carrying or otherwise conveying configuration information for configurable reflective device 215. Broadly, the configuration information may provide an indication of how configurable reflective device 215 is to configure each configurable subpanels 220 in order to reflect the downlink signal to UE 205 at a respective synchronization raster frequency from a second subset of the synchronization raster frequencies. Configurable reflective device 215 may reflect the downlink signals using one or more of the configurable subpanels 220 at the second subset of synchronization raster frequencies.

UE 205 may monitor the plurality of synchronization raster frequencies to identify a frequency of the downlink signal. Identifying the frequency of the downlink signal (e.g., associated with the strongest beam in the time domain as well as the strongest raster frequency in the frequency domain). More particular, UE 205 may monitor the plurality of synchronization raster frequencies to detect an SSB beam transmitted from base station 210. Based on the frequency of the strongest SSB beam, this may indicate whether the beam is a direct beam received from base station 210 (e.g., the first subset) or reflected from the RIS (e.g., the second subset). In some examples, this may be transparent to UE 205 (e.g., UE 205 may not even be aware of configurable reflective device 215 being used).

UE 205 may identify or otherwise determine the raster index associated with the frequency. For example, UE 205 may detect multiple SSB beams at frequencies from the plurality of synchronization raster frequencies. UE 205 may measure each SSB beam (e.g., downlink signal) to identify or otherwise determine which SSB beam has or will support the strongest RSRP, reference signal strength indicator (RSSI), the best channel quality indicator (CQI), the lowest interference level, the highest throughput rate, etc. UE 205 may also identify or otherwise determine the time (e.g., the absolute time and/or a relative time) that the strongest SSB beam was detected. UE 205 may identify or otherwise determine the raster index corresponding to the frequency of the strongest beam. Again, although UE 205 may be unaware of whether the strongest SSB beam was received directly from base station 210 or reflected from configurable reflective device 215, the raster index may provide an indication of this information.

Accordingly, UE 205 may transmit or otherwise provide an uplink signal to base station 210 carrying or otherwise conveying an indication of the raster index. This may provide an indication of the strongest SSB beam of UE 205, which may be used for further communications between UE 205 and base station 210. That is, the indication of the raster index from UE 205 may identify or otherwise indicate the strongest sub-raster (e.g., raster index) in the frequency domain in addition to the strongest beam (e.g., also indicating a beam index) in the time domain. UE 205 may also identify or otherwise determine the beam index of the determined strongest SSB beam and report this information in its uplink signal to base station 210. If the frequency of the raster index is from the first subset of the plurality of synchronization raster frequencies, this may indicate that the strongest beam of UE 205 was received directly from base station 210. If the frequency of the raster index is from the second subset of the plurality of synchronization raster frequencies, this may indicate that the strongest beam of UE 205 is a reflected beam that was received from configurable reflective device 215 (e.g., from a specific configurable subpanel 220, in some examples). Accordingly, UE 205 and base station 210 may perform subsequent communications based on the reported raster index (e.g., identifying the best SSB beam).

In some aspects, random access configurations may be configured or otherwise mapped to different raster indices. That is, UE 205 may associate each subraster (e.g., each raster index) with a different RACH occasion from a set of RACH occasions and/or a different RACH preamble from a set of RACH preambles. UE 205 initiating the initial access (e.g., a RACH procedure) with base station 210 using a specific RACH resource/configuration may provide the indication of the raster index. For example, UE 205 and/or base station 210 may identify or otherwise determine a random access configuration corresponding to (e.g., mapped to) the raster index to be used for the random access procedure with base station 210. The uplink signal in this example may correspond to a random access message transmitted according to the random access configuration corresponding to the raster index (e.g., using a RACH preamble and/or RACH occasion corresponding to the raster index).

As one non-limiting example where the random access configuration for the raster index corresponds to a specific random access occasion, UE 205 may transmit the random access message during the corresponding random access occasion. Base station 210 receiving the random access message during the random access occasion may determine the raster index based on the mapping between random access occasions and raster indices. As another non-limiting example where the random access configuration for the raster index corresponds to a specific random access preamble, UE 205 may transmit the random access message using the corresponding random access preamble. Base station 210 receiving the random access message using the random access preamble may determine the raster index based on the mapping between random access preambles and raster indices.

In some examples, base station 210 may identify which configurable subpanels 220 based on the indicated raster index. For example, base station 210 may determine that the strongest beam of UE 205 was received from configurable subpanel 220-a based on the indicated raster index, or some other configurable subpanel 220. Moreover, base station 210 may transmit control signaling to configurable reflective device 215 indicating updated configuration information for the configurable subpanel 220 associated with the strongest beam based on the indication (e.g., fine-tune the configurable subpanel 220 to improve beam performance).

Accordingly, wireless communication system 200 may provide support for both new or advanced UEs and legacy UEs to monitor the legacy raster. However, the new or advanced UE (e.g., an NR UE) may differentiate among different center frequencies on the legacy raster. From the perspective of the new or advanced UE, the center frequency 2400 MHZ+N*y*1.44 MHz+i*1.44 MHZ (where 0<i<y−1) may correspond to a reflection from RIS (e.g., configurable reflective device 215) with RIS beam i (where i maps to a specific configurable subpanel 220). Mapping the center frequency to the sync raster may be based on i=raster_idx-(f_c-2400 MHz)/1.44 MHz mod y. Again, UE 205 may associate each sub-raster (e.g., each raster index) with a different RACH occasion and/or RACH preamble. UE 205 may report the strongest sub-raster in the frequency domain in addition to the strongest beam in the time domain.

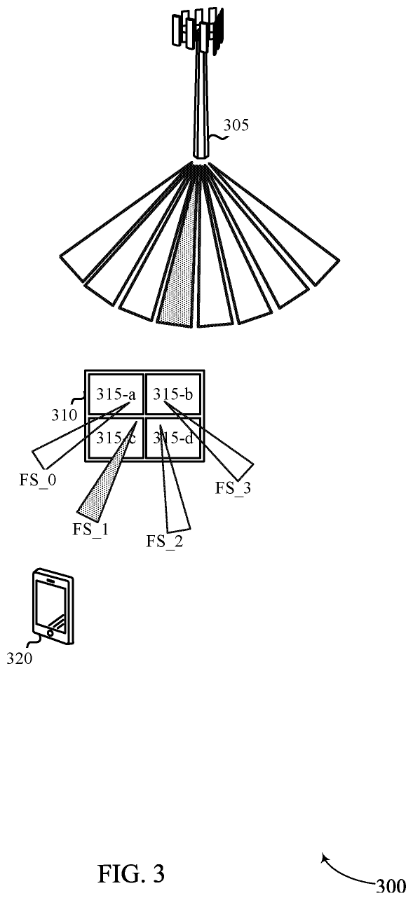

FIG. 3 illustrates an example of a wireless communication system 300 that supports backwards compatible one-shot initial access in accordance with aspects of the present disclosure. Wireless communication system 300 may implement aspects of wireless communication systems 100 and/or 200. Wireless communication system 300 may include base station 305, configurable reflective device 310 having a set of configurable subpanels 315, and UE 320, which may be examples of the corresponding devices described herein.

As discussed above, base station 305 may transmit or otherwise convey downlink signals in a beam-sweeping fashion. This may provide a mechanism for base station 305 to achieve directional transmissions within its associated coverage area. However, one or more configurable reflective device 310 may be configured within wireless communication system 300 to improve/extend the coverage area of base station 305 and/or to avoid interference/blockage. In the situation where configurable reflective device 310 is deployed, this may include base station 305 repeating the beamformed transmission using a subset of its beams (e.g., the beam shown in hatching) towards configurable reflective device 310. Configurable reflective device 310 may configure each of its configurable subpanels 315 to reflect the beam in a different direction and according to a frequency shift (e.g., watermarked). For example, configurable subpanel 315-a may reflect the beam in a first direction and at a first frequency shift (FS_0), configurable subpanels 315-b may reflect the beam in a second direction and at a second frequency shift (FS_1), configurable subpanels 315-c may reflect the beam in a third direction and at a third frequency shift (FS_2), and configurable subpanels 315-d may reflect the beam in a fourth direction and at a fourth frequency shift (FS_3). The frequency shifts in this example may be based on a raster that uses 2400 MHz+N*y*1.44 MHz, where y is the number of RIS beams to accommodate (e.g., based on the number of configurable subpanels 315 of configurable reflective device 310).

In the non-limiting example illustrated in FIG. 3, UE 320 may be positioned or otherwise located at a location where it receives the reflected beam from configurable subpanels 315-b at the second frequency shift (FS_1). Accordingly, UE 320 may measure, identify, or otherwise determine that the strongest beam of the downlink signal (which may be an SSB signal in some examples, or any other downlink signal in other examples) was received at a frequency (e.g., center frequency) that is based on the second frequency offset (FS_1). Accordingly, UE 305 may transmit or otherwise provide an uplink signal to base station 305 identifying or otherwise indicating the raster index associated with the frequency (e.g., based on FS_1). In this example, the frequency based on FS_1 may be from a second subset of the plurality of synchronization raster frequencies, which may indicate that the strongest beam of UE 320 was received as a reflected beam from configurable subpanels 315. As discussed above, UE 320 may indicate the raster index (and beam index in some examples) explicitly (e.g., using one or more bits, fields, information elements, etc.) and/or implicitly (e.g., each raster index is mapped to a corresponding RACH configuration).

Accordingly, base station 305 may identify or otherwise determine which frequency is associated with the strongest beam of UE 320 based on the indicated raster index. This may provide an indication to base station 305 of whether the strongest beam of UE 320 is a direct beam received from base station 305 or a reflected beam reflected from base station 305 towards UE 320 by configurable reflective device 310. Base station 305 and UE 320 may perform communications based on the indicated raster index (e.g., using the strongest beam of UE 320). For example, base station 305 may identify or otherwise determine which configurable subpanel 315 of configurable reflective device 310 is associated with the strongest beam of UE 320 based on the indicated raster index. Base station 305 may transmit or otherwise convey control signaling to configurable reflective device 310 indicating how configurable reflective device 310 is to configure each configurable subpanel 315 in order to steer the reflected beam in a given direction and according to the set of raster frequencies discussed above (e.g., based on the number of RIS beams). Accordingly, wireless communication system 300 provide a mechanism where the indicated raster index of the frequency is from a synchronization raster that includes a set of raster indices (e.g., the second subset of raster frequencies) that are determined based on the number of configurable subpanels 315 of configurable reflective device 310.

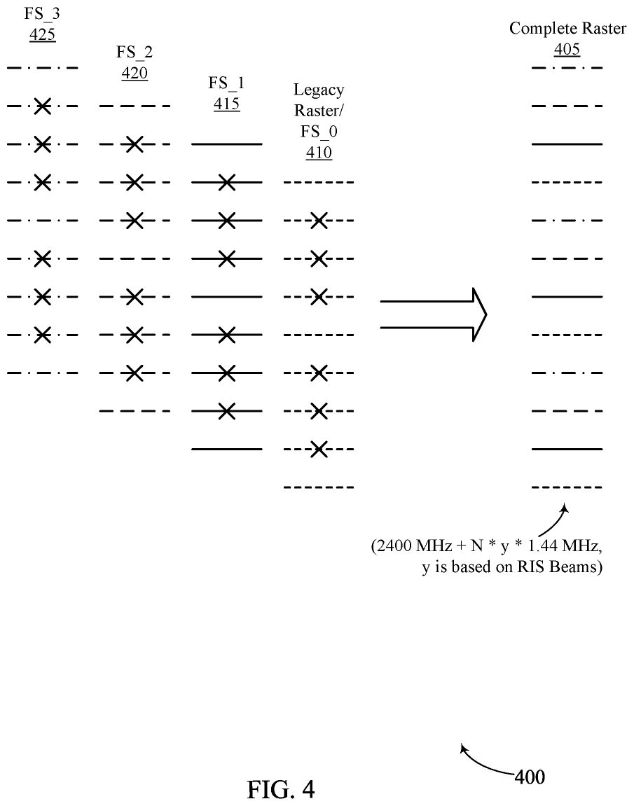

FIG. 4 illustrates an example of a raster configuration 400 that supports backwards compatible one-shot initial access in accordance with aspects of the present disclosure. Raster configuration 400 may implement aspects of wireless communication systems 100, 200, and/or 300. Aspects of raster configuration 400 may be implemented at or implemented by a UE, a base station, and/or a configurable reflective device.

Generally, raster configuration 400 includes a complete raster 405. The complete raster 405 may correspond to a synchronization raster associated with a configurable reflective device. For example, the synchronization raster (and associated raster indices) may be based on how many (e.g., the number of) configurable subpanels of the configurable reflective device.

For example, the complete raster 405 may be formed according to: 2400 MHz+N*y*1.44 MHz, where y is the number of RIS beams. It is to be understood that the number of RIS beams may be based on the number of configurable subpanels of the configurable reflective device, but may not necessarily correspond to the number of configurable subpanels. For example, the configurable reflective device may configure one or more subpanels to cooperatively reflect beams in more directions than the number of configurable subpanels. The complete raster 405 may, in some examples, correspond to the decimated raster discussed above.

The complete raster 405 may be formed according to the reflected beams of the reconfigurable reflective device. For example, a first configurable subpanel (and/or RIS beam) may be associated with a legacy raster and/or first frequency shift (FS_0). That is, the configurable reflective device may configure a first subpanel to reflect the beam from the base station at FS_0 410, which may correspond to the legacy raster. The configurable reflective device may configure a second subpanel to reflect the beam from the base station at a second frequency shift (FS_1) 415, which may correspond to a 1.44 MHz offset relative to the legacy raster. The configurable reflective device may configure a third subpanel to reflect the beam from the base station at a third frequency shift (FS_2) 420, which may correspond to a 2.88 MHz offset relative to the legacy raster. The configurable reflective device may configure a fourth subpanel to reflect the beam from the base station at a fourth frequency shift (FS_3) 425, which may correspond to a 4.32 MHz offset relative to the legacy raster.

Accordingly, the complete raster 405 associated with the configurable reflective device may be formed initially by a reflected beam from the first subpanel at FS_0 410, from the second subpanel at FS_1 415, from the third subpanel at FS_2 420, and from the fourth subpanel at FS_3 425. This may permit both legacy and new or advanced UEs to monitor the complete raster 405. Legacy UEs may report their strongest beam based on monitoring the legacy raster (e.g., as these legacy UEs may not be aware of the complete raster 405 associated with the configurable reflective device). However, new or advanced UEs may report their strongest beam including the raster index to the base station. The base station may receive the uplink signal from the UE and, based on the indicated raster index, identify or otherwise determine whether the strongest beam for the UE is a direct beam received from the base station or a beam reflected from the configurable reflective device at a given frequency offset. Accordingly, the UE and base station may perform communications based on the indicated raster index (identifying the strongest beam) in the frequency domain and the strongest beam (e.g., based on the indicated beam index) in the time domain.

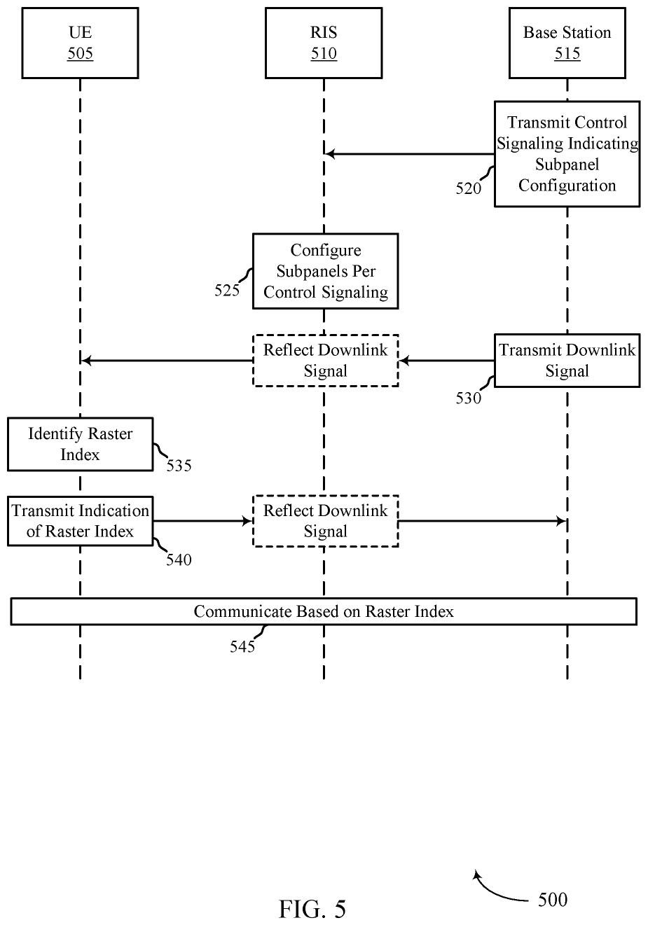

FIG. 5 illustrates an example of a process 500 that supports backwards compatible one-shot initial access in accordance with aspects of the present disclosure. Process 500 may implement aspects of wireless communication systems 100, 200, and/or 300, and/or raster configuration 400. Aspects of process 500 may be implemented at or implemented by UE 505, RIS 510 (e.g., a reconfigurable reflective device), and/or base station 515, which may be examples of the corresponding devices described herein.

At 520, base station 515 may transmit or otherwise provide (and RIS 510 may receive or otherwise obtain) control signaling identifying or otherwise indicating how RIS 510 is to configure each subpanel to reflect the downlink signal to UE 505 at a respective synchronization raster frequency. That is, base station 515 may generally transmit downlink signals to UE 505 at a frequency from a first subset of a plurality of the synchronization raster frequencies and RIS 510 may reflect downlink signals from base station 515 to UE 505 at respective raster frequencies from a second subset of the plurality of synchronization raster frequencies.

At 525, RIS 510 may configure each configurable subpanel of its set of configurable subpanels according to the control signaling. For example, RIS 510 may configure a first subpanel to reflect the downlink signal in a first direction and at a first frequency shift (FS_0), configure a second subpanel to reflect the downlink signal in a second direction and at a second frequency shift (FS_1), and so forth.

At 530, base station 515 transmit or otherwise provide a downlink signal to UE 505. For example, base station 515 may transmit the downlink signal at the first frequency from the first subset of raster frequencies and RIS 510 may reflect the downlink signal at respective synchronization raster frequencies from the second subset of raster frequencies. Accordingly, UE 505 may monitor the synchronization raster frequencies (e.g., of raster 405) and receive the downlink signal from base station 515.

At 535, UE raster index associated with the frequency (e.g., the raster index within raster 405 of the frequency associated with the strongest beam of UE 505). For example, UE 505 may measure each synchronization raster frequency of raster 405 to identify or otherwise determine the strongest beam. UE 505 may identify or otherwise determine the frequency associated with the strongest beam and determine the raster index of that frequency. In some examples, this may include UE 505 identifying or otherwise determining the strongest raster in the frequency domain as well as the strongest beam in the time domain (e.g., based on base station 515 repeating transmission of the downlink signal at the first frequency and RIS 510 reflecting each transmission in a different direction and at a different frequency offset).

At 540, UE 505 may transmit or otherwise provide an uplink signal to base station 515 identifying or otherwise indicating the raster index. For example, UE 505 may transmit the uplink signal directly to base station 515 and/or may reflect the uplink signal off of RIS 510 towards base station 515. UE 505 may configure the uplink signal to indicate the raster index explicitly (e.g., using one or more bits, fields, information elements, etc.) and/or implicitly (e.g., by choosing a random access configuration mapped to the raster index).

Accordingly, at 545 UE 505 and base station 515 may perform communications based at least in part on the indicated raster index. That is, the indicated raster index may provide an indication of whether UE 505 received the downlink signal directly from base station 515 or received the downlink signal reflected from one of the subpanels of RIS 510. This may provide an indication of the best beam of UE 505, which may be leveraged for subsequent communications between UE 505 and base station 515.

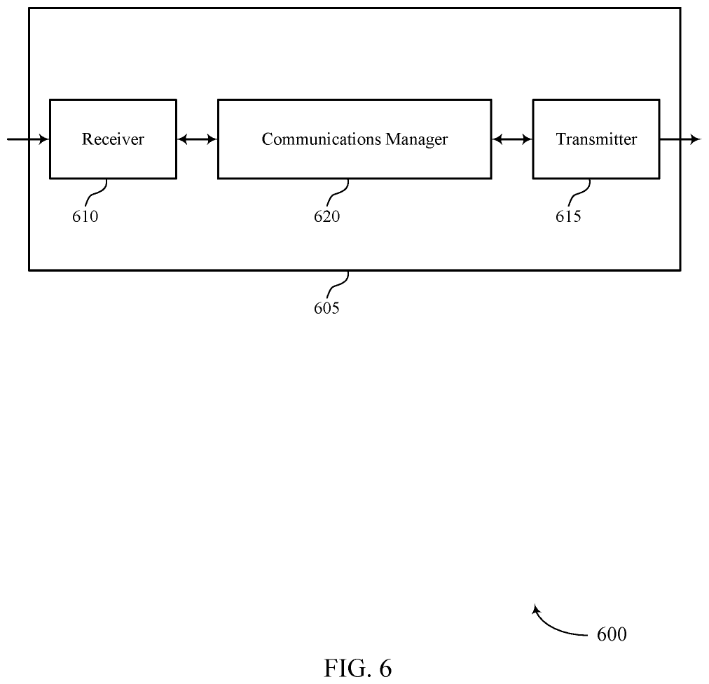

FIG. 6 shows a block diagram 600 of a device 605 that supports backwards compatible one-shot initial access in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to backwards compatible one-shot initial access). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to backwards compatible one-shot initial access). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of backwards compatible one-shot initial access as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for monitoring a set of multiple synchronization raster frequencies to identify a frequency of a downlink signal transmitted from a base station, a first subset of the set of multiple synchronization raster frequencies corresponding to the UE receiving the downlink signal from the base station and a second subset of the set of multiple synchronization raster frequencies corresponding to the UE receiving the downlink signal from the base station via a configurable reflective device. The communications manager 620 may be configured as or otherwise support a means for identifying a raster index associated with the frequency, the raster index corresponding to one of receiving the downlink signal from the base station or receiving the downlink signal from the base station via the configurable reflective device. The communications manager 620 may be configured as or otherwise support a means for transmitting an uplink signal to the base station indicating the raster index.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for application of a synchronization raster configured for a RIS based on the number of RIS beams which may be monitored by both legacy UEs as well as new or advanced UEs.

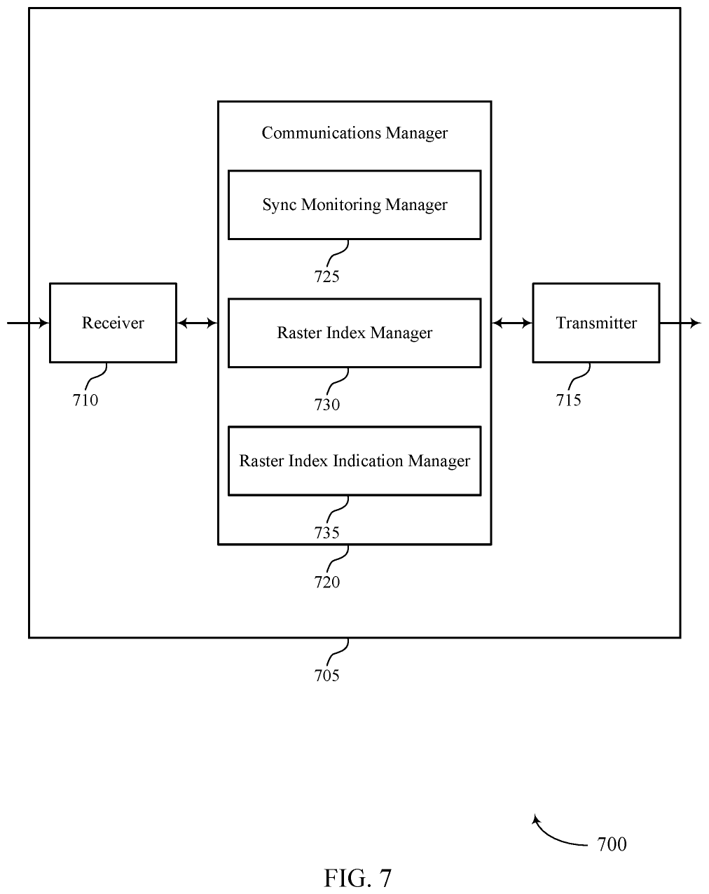

FIG. 7 shows a block diagram 700 of a device 705 that supports backwards compatible one-shot initial access in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to backwards compatible one-shot initial access). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to backwards compatible one-shot initial access). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of backwards compatible one-shot initial access as described herein. For example, the communications manager 720 may include a sync monitoring manager 725, a raster index manager 730, a raster index indication manager 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The sync monitoring manager 725 may be configured as or otherwise support a means for monitoring a set of multiple synchronization raster frequencies to identify a frequency of a downlink signal transmitted from a base station, a first subset of the set of multiple synchronization raster frequencies corresponding to the UE receiving the downlink signal from the base station and a second subset of the set of multiple synchronization raster frequencies corresponding to the UE receiving the downlink signal from the base station via a configurable reflective device. The raster index manager 730 may be configured as or otherwise support a means for identifying a raster index associated with the frequency, the raster index corresponding to one of receiving the downlink signal from the base station or receiving the downlink signal from the base station via the configurable reflective device. The raster index indication manager 735 may be configured as or otherwise support a means for transmitting an uplink signal to the base station indicating the raster index.

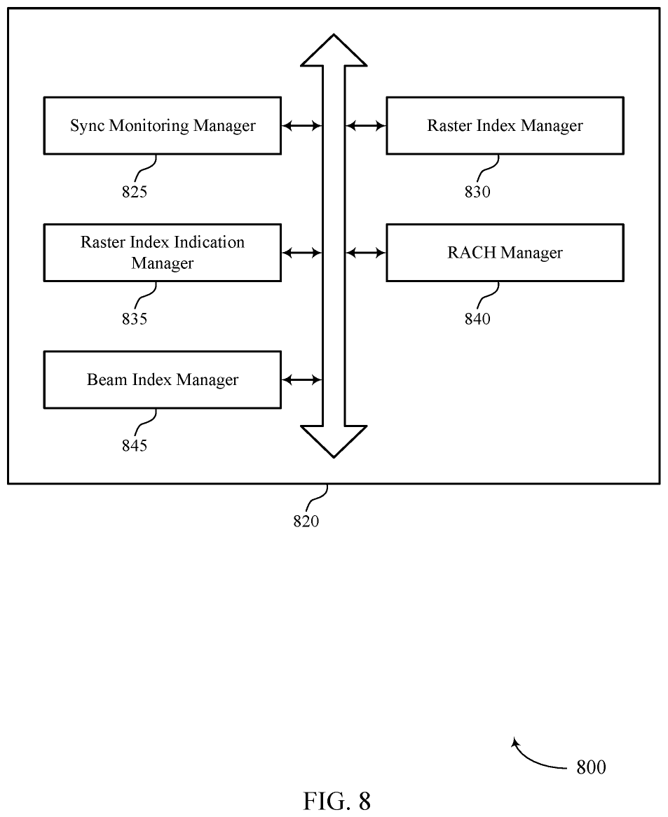

FIG. 8 shows a block diagram 800 of a communications manager 820 that supports backwards compatible one-shot initial access in accordance with aspects of the present disclosure. The communications manager 820 may be an example of aspects of a communications manager 620, a communications manager 720, or both, as described herein. The communications manager 820, or various components thereof, may be an example of means for performing various aspects of backwards compatible one-shot initial access as described herein. For example, the communications manager 820 may include a sync monitoring manager 825, a raster index manager 830, a raster index indication manager 835, a RACH manager 840, a beam index manager 845, or any combination thereof. Each of these components may communicate, directly or indirectly, with one another (e.g., via one or more buses).

The communications manager 820 may support wireless communication at a UE in accordance with examples as disclosed herein. The sync monitoring manager 825 may be configured as or otherwise support a means for monitoring a set of multiple synchronization raster frequencies to identify a frequency of a downlink signal transmitted from a base station, a first subset of the set of multiple synchronization raster frequencies corresponding to the UE receiving the downlink signal from the base station and a second subset of the set of multiple synchronization raster frequencies corresponding to the UE receiving the downlink signal from the base station via a configurable reflective device. The raster index manager 830 may be configured as or otherwise support a means for identifying a raster index associated with the frequency, the raster index corresponding to one of receiving the downlink signal from the base station or receiving the downlink signal from the base station via the configurable reflective device. The raster index indication manager 835 may be configured as or otherwise support a means for transmitting an uplink signal to the base station indicating the raster index.

In some examples, the RACH manager 840 may be configured as or otherwise support a means for identifying a random access configuration corresponding to the raster index to use during a random access procedure with the base station. In some examples, the RACH manager 840 may be configured as or otherwise support a means for transmitting one or more random access messages according to the random access configuration. In some examples, to support transmitting the one or more random access messages, the RACH manager 840 may be configured as or otherwise support a means for transmitting the one or more random access messages during a random access occasion selected from a set of multiple available random access occasions, where the random access configuration indicates the random access occasion corresponding to the raster index.

In some examples, to support transmitting the one or more random access messages, the RACH manager 840 may be configured as or otherwise support a means for transmitting the one or more random access messages including a random access preamble selected from a set of multiple available random access preambles, where the random access configuration indicates the random access preamble corresponding to the raster index.

In some examples, the raster index indication manager 835 may be configured as or otherwise support a means for transmitting, based on the monitoring, the uplink signal indicating the raster index in a frequency domain and a beam index in a time domain corresponding to the downlink signal.

In some examples, the beam index manager 845 may be configured as or otherwise support a means for identifying a beam index associated with the downlink signal transmitted from the base station, where the beam index is based on the raster index and the uplink signal indicates the beam index. In some examples, the first subset of the set of multiple synchronization raster frequencies are associated with a network configured synchronization raster and the second subset of the set of multiple synchronization raster frequencies include offset frequencies relative to a default network configured synchronization raster.

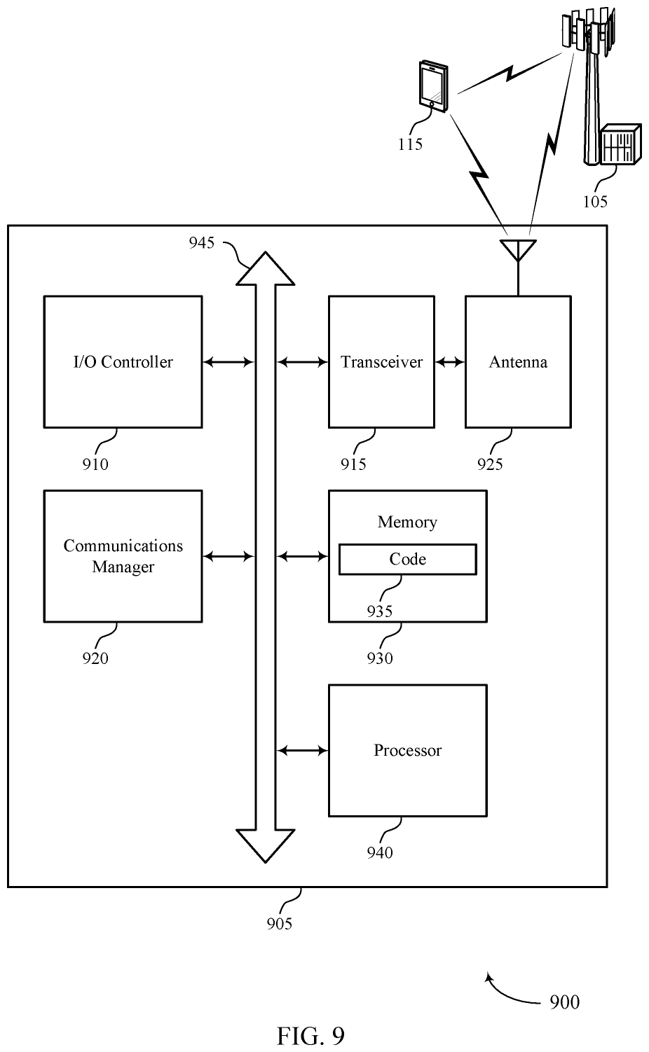

FIG. 9 shows a diagram of a system 900 including a device 905 that supports backwards compatible one-shot initial access in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROIDR, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting backwards compatible one-shot initial access). For example, the device 905 or a component of the device 905 may include a processor 940 and memory 930 coupled to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for monitoring a set of multiple synchronization raster frequencies to identify a frequency of a downlink signal transmitted from a base station, a first subset of the set of multiple synchronization raster frequencies corresponding to the UE receiving the downlink signal from the base station and a second subset of the set of multiple synchronization raster frequencies corresponding to the UE receiving the downlink signal from the base station via a configurable reflective device. The communications manager 920 may be configured as or otherwise support a means for identifying a raster index associated with the frequency, the raster index corresponding to one of receiving the downlink signal from the base station or receiving the downlink signal from the base station via the configurable reflective device. The communications manager 920 may be configured as or otherwise support a means for transmitting an uplink signal to the base station indicating the raster index.

By including or configuring the communications manager 920 in accordance with examples as described herein, the device 905 may support techniques for application of a synchronization raster configured for a RIS based on the number of RIS beams which may be monitored by both legacy UEs as well as new or advanced UEs.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of backwards compatible one-shot initial access as described herein, or the processor 940 and the memory 930 may be otherwise configured to perform or support such operations.

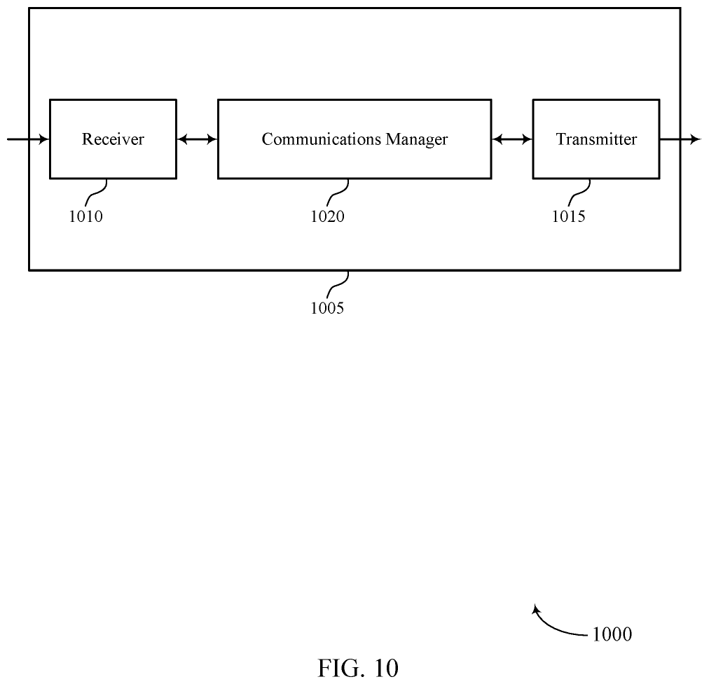

FIG. 10 shows a block diagram 1000 of a device 1005 that supports backwards compatible one-shot initial access in accordance with aspects of the present disclosure. The device 1005 may be an example of aspects of a base station 105 and/or RIS as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to backwards compatible one-shot initial access). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to backwards compatible one-shot initial access). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of backwards compatible one-shot initial access as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. For example, the communications manager 1020 may be configured as or otherwise support a means for transmitting a downlink signal to a user equipment (UE) via a first frequency of a first subset of a set of multiple synchronization raster frequencies. The communications manager 1020 may be configured as or otherwise support a means for receiving an uplink signal from the UE indicating a raster index, the raster index associated with a frequency of the downlink signal identified by the UE, the raster index corresponding to the UE one of receiving the downlink signal from the base station via the first frequency or receiving the downlink signal from the base station via a second frequency of a second subset of the set of multiple synchronization raster frequencies corresponding to the UE receiving the downlink signal from the base station via a configurable reflective device. The communications manager 1020 may be configured as or otherwise support a means for communicating with the UE based on the raster index indicated in the uplink signal.

Additionally or alternatively, the communications manager 1020 may support wireless communication at a configurable reflective device in accordance with examples as disclosed herein. For example, the communications manager 1020 may be configured as or otherwise support a means for receiving, from a base station, a downlink signal at a frequency from a first subset of a set of multiple synchronization raster frequencies. The communications manager 1020 may be configured as or otherwise support a means for receiving, from the base station, control signaling indicating to configure each configurable subpanel of a set of configurable subpanels of the configurable reflective device to reflect the downlink signal to a UE at a respective synchronization raster frequency from a second subset of the set of multiple synchronization raster frequencies. The communications manager 1020 may be configured as or otherwise support a means for receiving an uplink signal from the UE indicating a raster index corresponding to one of the respective synchronization raster frequencies from the first subset or the second subset of the set of multiple synchronization raster frequencies.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for application of a synchronization raster configured for a RIS based on the number of RIS beams which may be monitored by both legacy UEs as well as new or advanced UEs.

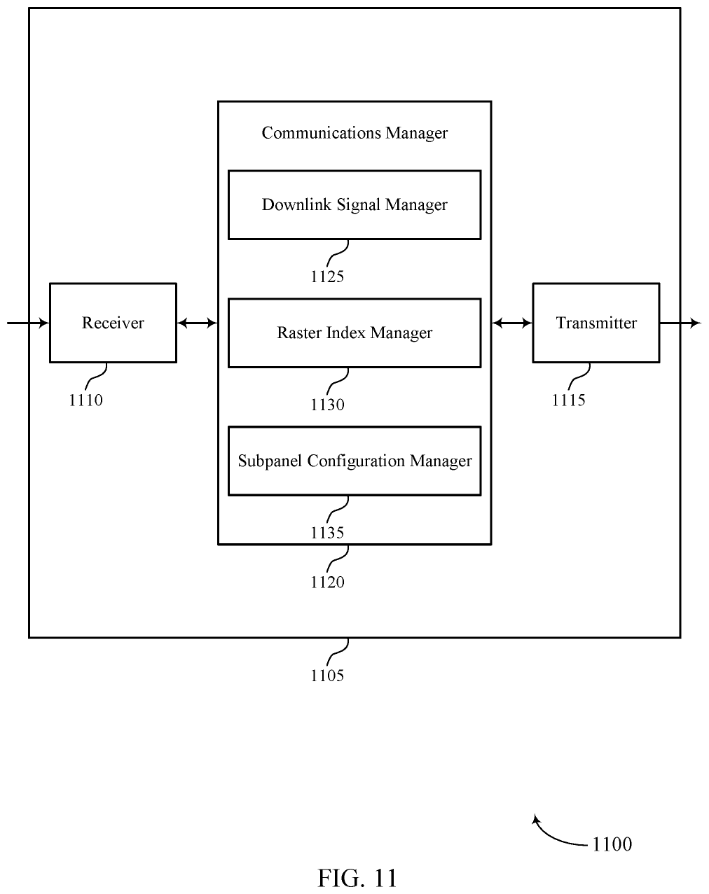

FIG. 11 shows a block diagram 1100 of a device 1105 that supports backwards compatible one-shot initial access in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to backwards compatible one-shot initial access). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to backwards compatible one-shot initial access). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of backwards compatible one-shot initial access as described herein. For example, the communications manager 1120 may include a downlink signal manager 1125, a raster index manager 1130, a subpanel configuration manager 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a base station in accordance with examples as disclosed herein. The downlink signal manager 1125 may be configured as or otherwise support a means for transmitting a downlink signal to a user equipment (UE) via a first frequency of a first subset of a set of multiple synchronization raster frequencies. The raster index manager 1130 may be configured as or otherwise support a means for receiving an uplink signal from the UE indicating a raster index, the raster index associated with a frequency of the downlink signal identified by the UE, the raster index corresponding to the UE one of receiving the downlink signal from the base station via the first frequency or receiving the downlink signal from the base station via a second frequency of a second subset of the set of multiple synchronization raster frequencies corresponding to the UE receiving the downlink signal from the base station via a configurable reflective device. The raster index manager 1130 may be configured as or otherwise support a means for communicating with the UE based on the raster index indicated in the uplink signal.

Additionally or alternatively, the communications manager 1120 may support wireless communication at a configurable reflective device in accordance with examples as disclosed herein. The downlink signal manager 1125 may be configured as or otherwise support a means for receiving, from a base station, a downlink signal at a frequency from a first subset of a set of multiple synchronization raster frequencies. The subpanel configuration manager 1135 may be configured as or otherwise support a means for receiving, from the base station, control signaling indicating to configure each configurable subpanel of a set of configurable subpanels of the configurable reflective device to reflect the downlink signal to a UE at a respective synchronization raster frequency from a second subset of the set of multiple synchronization raster frequencies. The raster index manager 1130 may be configured as or otherwise support a means for receiving an uplink signal from the UE indicating a raster index corresponding to one of the respective synchronization raster frequencies from the first subset or the second subset of the set of multiple synchronization raster frequencies.

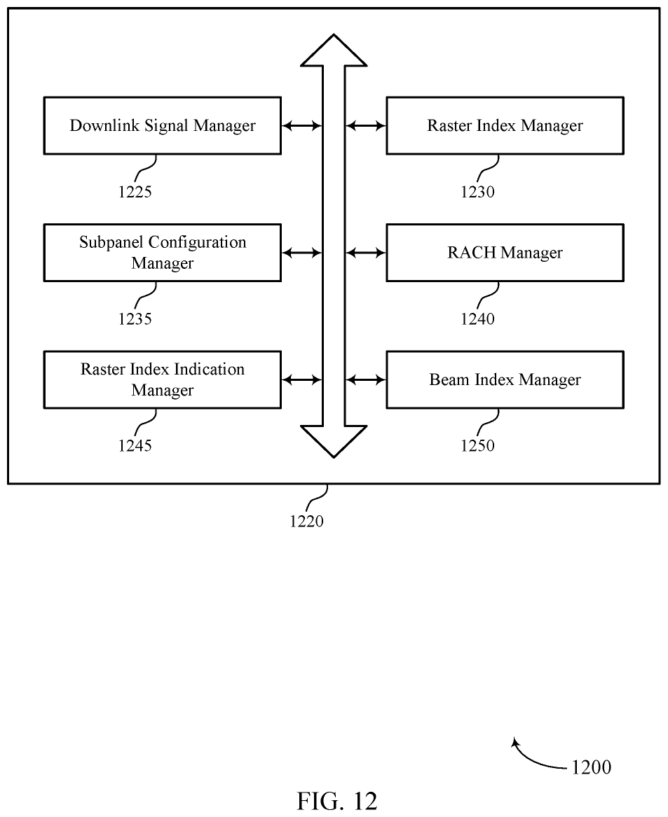

FIG. 12 shows a block diagram 1200 of a communications manager 1220 that supports backwards compatible one-shot initial access in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of backwards compatible one-shot initial access as described herein. For example, the communications manager 1220 may include a downlink signal manager 1225, a raster index manager 1230, a subpanel configuration manager 1235, a RACH manager 1240, a raster index indication manager 1245, a beam index manager 1250, or any combination thereof. Each of these components may communicate, directly or indirectly, with one another (e.g., via one or more buses).

The communications manager 1220 may support wireless communication at a base station in accordance with examples as disclosed herein. The downlink signal manager 1225 may be configured as or otherwise support a means for transmitting a downlink signal to a user equipment (UE) via a first frequency of a first subset of a set of multiple synchronization raster frequencies. The raster index manager 1230 may be configured as or otherwise support a means for receiving an uplink signal from the UE indicating a raster index, the raster index associated with a frequency of the downlink signal identified by the UE, the raster index corresponding to the UE one of receiving the downlink signal from the base station via the first frequency or receiving the downlink signal from the base station via a second frequency of a second subset of the set of multiple synchronization raster frequencies corresponding to the UE receiving the downlink signal from the base station via a configurable reflective device. In some examples, the raster index manager 1230 may be configured as or otherwise support a means for communicating with the UE based on the raster index indicated in the uplink signal.

In some examples, the subpanel configuration manager 1235 may be configured as or otherwise support a means for identifying, based on the raster index, a configurable subpanel of a set of configurable subpanels of the configurable reflective device used to reflect the downlink signal from the base station to the UE. In some examples, each configurable subpanel of the set of configurable subpanels is associated with a respective frequency and each frequency of the respective frequencies is associated with a respective raster index.

In some examples, the RACH manager 1240 may be configured as or otherwise support a means for receiving one or more random access messages from the UE according to a random access configuration, the random access configuration corresponding to the raster index. In some examples, to support receiving the one or more random access messages, the RACH manager 1240 may be configured as or otherwise support a means for receiving the one or more random access messages during a random access occasion selected from a set of multiple available random access occasions, where the random access configuration indicates the random access occasion corresponding to the raster index.

In some examples, to support receiving the one or more random access messages, the RACH manager 1240 may be configured as or otherwise support a means for receiving the one or more random access messages including a random access preamble selected from a set of multiple available random access preambles, where the random access configuration indicates the random access preamble corresponding to the raster index.

In some examples, the raster index indication manager 1245 may be configured as or otherwise support a means for receiving the uplink signal indicating the raster index in a frequency domain and a beam index in a time domain corresponding to the downlink signal.

In some examples, the beam index manager 1250 may be configured as or otherwise support a means for identifying, based on the raster index, a beam index associated with the downlink signal, where the beam index corresponds to the raster index and the uplink signal indicates the beam index. In some examples, the raster index associated with the frequency is from a synchronization raster associated with the configurable reflective device and the synchronization raster includes a set of raster indices that are based on a number of configurable subpanels of the configurable reflective device.

Additionally or alternatively, the communications manager 1220 may support wireless communication at a configurable reflective device in accordance with examples as disclosed herein. In some examples, the downlink signal manager 1225 may be configured as or otherwise support a means for receiving, from a base station, a downlink signal at a frequency from a first subset of a set of multiple synchronization raster frequencies. The subpanel configuration manager 1235 may be configured as or otherwise support a means for receiving, from the base station, control signaling indicating to configure each configurable subpanel of a set of configurable subpanels of the configurable reflective device to reflect the downlink signal to a UE at a respective synchronization raster frequency from a second subset of the set of multiple synchronization raster frequencies. In some examples, the raster index manager 1230 may be configured as or otherwise support a means for receiving an uplink signal from the UE indicating a raster index corresponding to one of the respective synchronization raster frequencies from the first subset or the second subset of the set of multiple synchronization raster frequencies.

In some examples, the subpanel configuration manager 1235 may be configured as or otherwise support a means for reflecting the uplink signal from the UE to the base station via at least one configurable subpanel of the set of configurable subpanels.

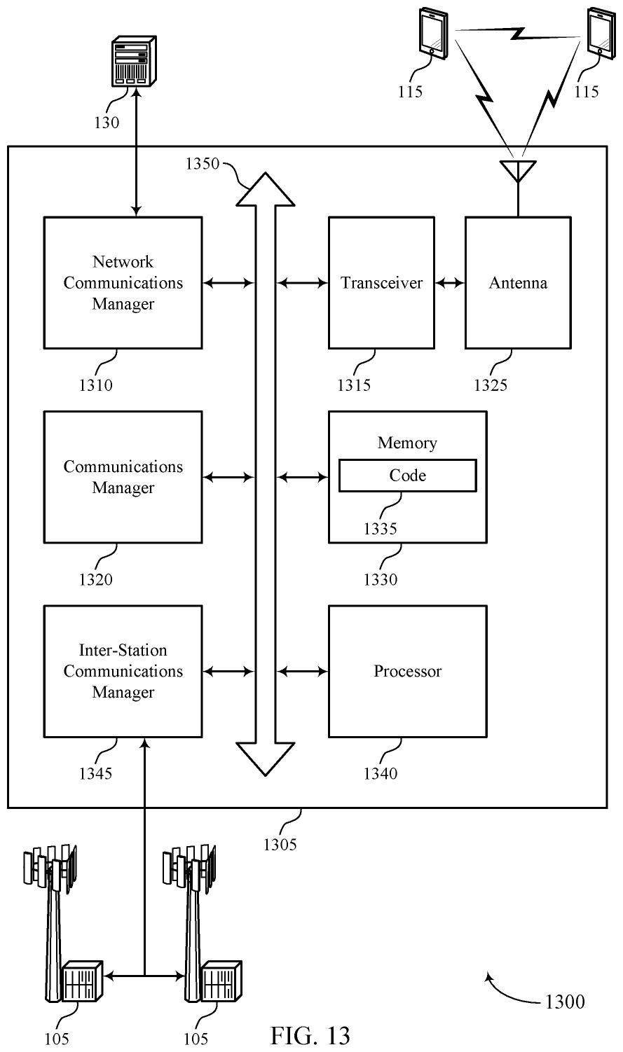

FIG. 13 shows a diagram of a system 1300 including a device 1305 that supports backwards compatible one-shot initial access in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting backwards compatible one-shot initial access). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communication at a base station in accordance with examples as disclosed herein. For example, the communications manager 1320 may be configured as or otherwise support a means for transmitting a downlink signal to a user equipment (UE) via a first frequency of a first subset of a set of multiple synchronization raster frequencies. The communications manager 1320 may be configured as or otherwise support a means for receiving an uplink signal from the UE indicating a raster index, the raster index associated with a frequency of the downlink signal identified by the UE, the raster index corresponding to the UE one of receiving the downlink signal from the base station via the first frequency or receiving the downlink signal from the base station via a second frequency of a second subset of the set of multiple synchronization raster frequencies corresponding to the UE receiving the downlink signal from the base station via a configurable reflective device. The communications manager 1320 may be configured as or otherwise support a means for communicating with the UE based on the raster index indicated in the uplink signal.

Additionally or alternatively, the communications manager 1320 may support wireless communication at a configurable reflective device in accordance with examples as disclosed herein. For example, the communications manager 1320 may be configured as or otherwise support a means for receiving, from a base station, a downlink signal at a frequency from a first subset of a set of multiple synchronization raster frequencies. The communications manager 1320 may be configured as or otherwise support a means for receiving, from the base station, control signaling indicating to configure each configurable subpanel of a set of configurable subpanels of the configurable reflective device to reflect the downlink signal to a UE at a respective synchronization raster frequency from a second subset of the set of multiple synchronization raster frequencies. The communications manager 1320 may be configured as or otherwise support a means for receiving an uplink signal from the UE indicating a raster index corresponding to one of the respective synchronization raster frequencies from the first subset or the second subset of the set of multiple synchronization raster frequencies.

By including or configuring the communications manager 1320 in accordance with examples as described herein, the device 1305 may support techniques for application of a synchronization raster configured for a RIS based on the number of RIS beams which may be monitored by both legacy UEs as well as new or advanced UEs.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of backwards compatible one-shot initial access as described herein, or the processor 1340 and the memory 1330 may be otherwise configured to perform or support such operations.

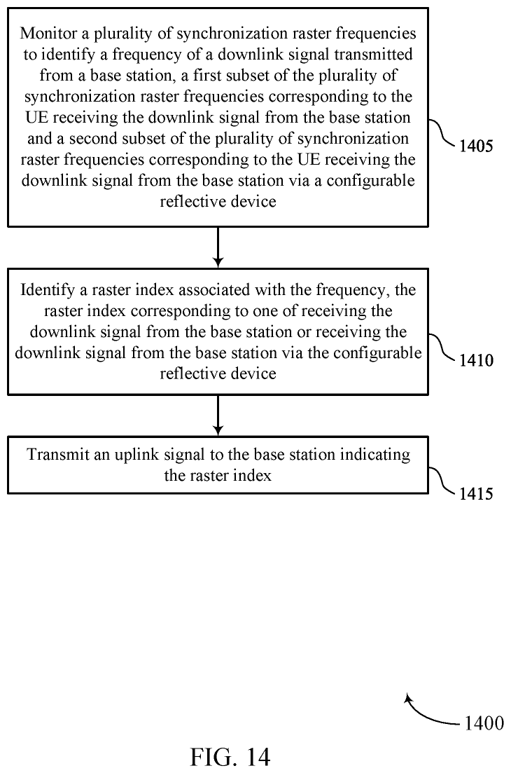

FIG. 14 shows a flowchart illustrating a method 1400 that supports backwards compatible one-shot initial access in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include monitoring a set of multiple synchronization raster frequencies to identify a frequency of a downlink signal transmitted from a base station, a first subset of the set of multiple synchronization raster frequencies corresponding to the UE receiving the downlink signal from the base station and a second subset of the set of multiple synchronization raster frequencies corresponding to the UE receiving the downlink signal from the base station via a configurable reflective device. The operations of 1405 may be performed in accordance with examples as disclosed herein. In some examples, aspects of the operations of 1405 may be performed by a sync monitoring manager 825 as described with reference to FIG. 8.

At 1410, the method may include identifying a raster index associated with the frequency, the raster index corresponding to one of receiving the downlink signal from the base station or receiving the downlink signal from the base station via the configurable reflective device. The operations of 1410 may be performed in accordance with examples as disclosed herein. In some examples, aspects of the operations of 1410 may be performed by a raster index manager 830 as described with reference to FIG. 8.

At 1415, the method may include transmitting an uplink signal to the base station indicating the raster index. The operations of 1415 may be performed in accordance with examples as disclosed herein. In some examples, aspects of the operations of 1415 may be performed by a raster index indication manager 835 as described with reference to FIG. 8.

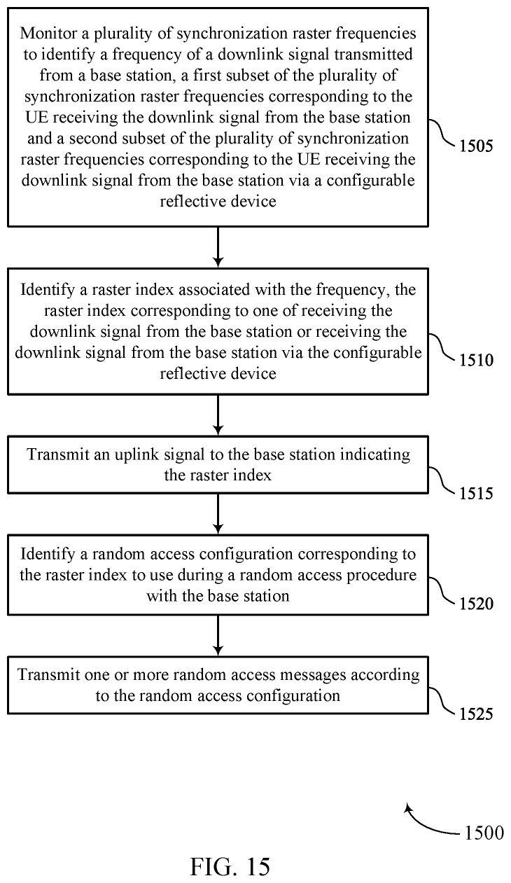

FIG. 15 shows a flowchart illustrating a method 1500 that supports backwards compatible one-shot initial access in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include monitoring a set of multiple synchronization raster frequencies to identify a frequency of a downlink signal transmitted from a base station, a first subset of the set of multiple synchronization raster frequencies corresponding to the UE receiving the downlink signal from the base station and a second subset of the set of multiple synchronization raster frequencies corresponding to the UE receiving the downlink signal from the base station via a configurable reflective device. The operations of 1505 may be performed in accordance with examples as disclosed herein. In some examples, aspects of the operations of 1505 may be performed by a sync monitoring manager 825 as described with reference to FIG. 8.

At 1510, the method may include identifying a raster index associated with the frequency, the raster index corresponding to one of receiving the downlink signal from the base station or receiving the downlink signal from the base station via the configurable reflective device. The operations of 1510 may be performed in accordance with examples as disclosed herein. In some examples, aspects of the operations of 1510 may be performed by a raster index manager 830 as described with reference to FIG. 8.

At 1515, the method may include transmitting an uplink signal to the base station indicating the raster index. The operations of 1515 may be performed in accordance with examples as disclosed herein. In some examples, aspects of the operations of 1515 may be performed by a raster index indication manager 835 as described with reference to FIG. 8.

At 1520, the method may include identifying a random access configuration corresponding to the raster index to use during a random access procedure with the base station. The operations of 1520 may be performed in accordance with examples as disclosed herein. In some examples, aspects of the operations of 1520 may be performed by a RACH manager 840 as described with reference to FIG. 8.

At 1525, the method may include transmitting one or more random access messages according to the random access configuration. The operations of 1525 may be performed in accordance with examples as disclosed herein. In some examples, aspects of the operations of 1525 may be performed by a RACH manager 840 as described with reference to FIG. 8.

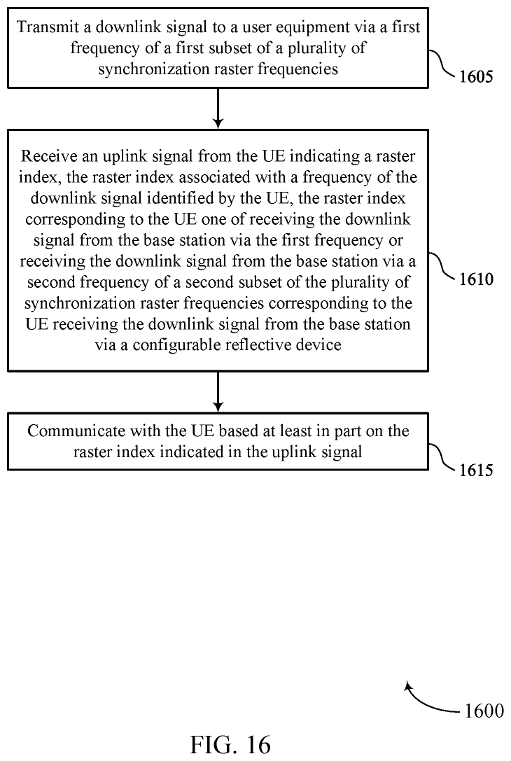

FIG. 16 shows a flowchart illustrating a method 1600 that supports backwards compatible one-shot initial access in accordance with aspects of the present disclosure. The operations of the method 1600 may be implemented by a base station or its components as described herein. For example, the operations of the method 1600 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1605, the method may include transmitting a downlink signal to a user equipment (UE) via a first frequency of a first subset of a set of multiple synchronization raster frequencies. The operations of 1605 may be performed in accordance with examples as disclosed herein. In some examples, aspects of the operations of 1605 may be performed by a downlink signal manager 1225 as described with reference to FIG. 12.

At 1610, the method may include receiving an uplink signal from the UE indicating a raster index, the raster index associated with a frequency of the downlink signal identified by the UE, the raster index corresponding to the UE one of receiving the downlink signal from the base station via the first frequency or receiving the downlink signal from the base station via a second frequency of a second subset of the set of multiple synchronization raster frequencies corresponding to the UE receiving the downlink signal from the base station via a configurable reflective device. The operations of 1610 may be performed in accordance with examples as disclosed herein. In some examples, aspects of the operations of 1610 may be performed by a raster index manager 1230 as described with reference to FIG. 12.

At 1615, the method may include communicating with the UE based on the raster index indicated in the uplink signal. The operations of 1615 may be performed in accordance with examples as disclosed herein. In some examples, aspects of the operations of 1615 may be performed by a raster index manager 1230 as described with reference to FIG. 12.

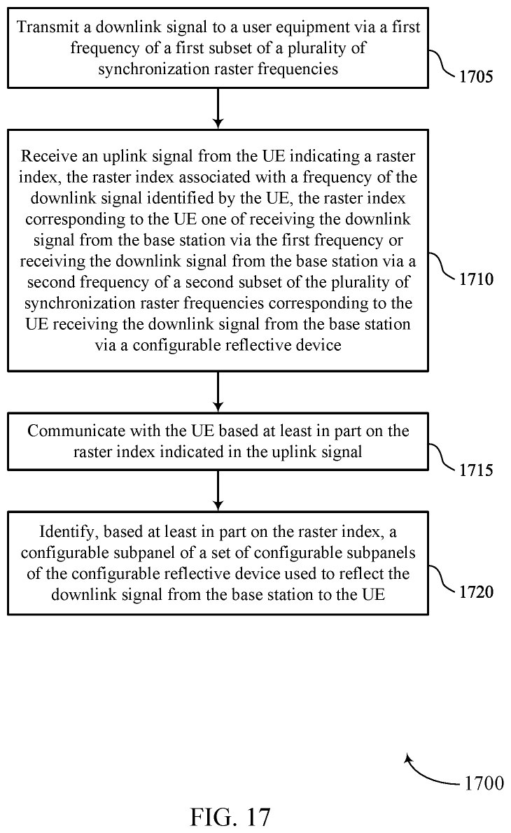

FIG. 17 shows a flowchart illustrating a method 1700 that supports backwards compatible one-shot initial access in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1705, the method may include transmitting a downlink signal to a user equipment (UE) via a first frequency of a first subset of a set of multiple synchronization raster frequencies. The operations of 1705 may be performed in accordance with examples as disclosed herein. In some examples, aspects of the operations of 1705 may be performed by a downlink signal manager 1225 as described with reference to FIG. 12.

At 1710, the method may include receiving an uplink signal from the UE indicating a raster index, the raster index associated with a frequency of the downlink signal identified by the UE, the raster index corresponding to the UE one of receiving the downlink signal from the base station via the first frequency or receiving the downlink signal from the base station via a second frequency of a second subset of the set of multiple synchronization raster frequencies corresponding to the UE receiving the downlink signal from the base station via a configurable reflective device. The operations of 1710 may be performed in accordance with examples as disclosed herein. In some examples, aspects of the operations of 1710 may be performed by a raster index manager 1230 as described with reference to FIG. 12.

At 1715, the method may include communicating with the UE based on the raster index indicated in the uplink signal. The operations of 1715 may be performed in accordance with examples as disclosed herein. In some examples, aspects of the operations of 1715 may be performed by a raster index manager 1230 as described with reference to FIG. 12.

At 1720, the method may include identifying, based on the raster index, a configurable subpanel of a set of configurable subpanels of the configurable reflective device used to reflect the downlink signal from the base station to the UE. The operations of 1720 may be performed in accordance with examples as disclosed herein. In some examples, aspects of the operations of 1720 may be performed by a subpanel configuration manager 1235 as described with reference to FIG. 12.

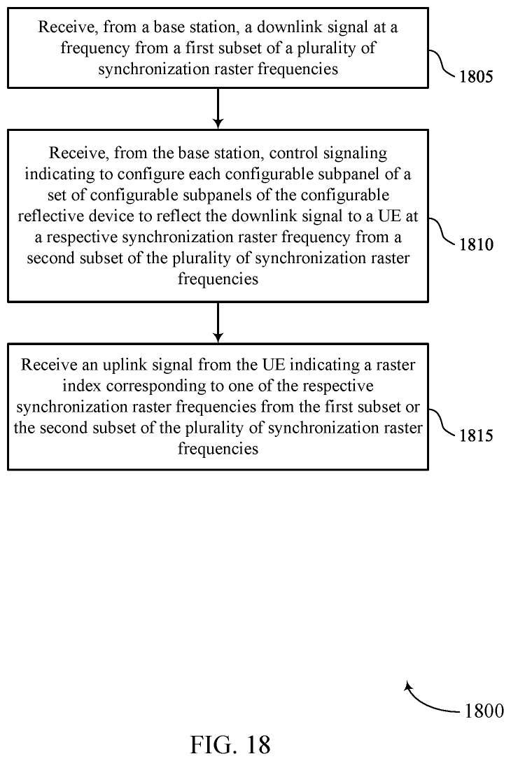

FIG. 18 shows a flowchart illustrating a method 1800 that supports backwards compatible one-shot initial access in accordance with aspects of the present disclosure. The operations of the method 1800 may be implemented by a base station or its components as described herein. For example, the operations of the method 1800 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1805, the method may include receiving, from a base station, a downlink signal at a frequency from a first subset of a set of multiple synchronization raster frequencies. The operations of 1805 may be performed in accordance with examples as disclosed herein. In some examples, aspects of the operations of 1805 may be performed by a downlink signal manager 1225 as described with reference to FIG. 12.

At 1810, the method may include receiving, from the base station, control signaling indicating to configure each configurable subpanel of a set of configurable subpanels of the configurable reflective device to reflect the downlink signal to a UE at a respective synchronization raster frequency from a second subset of the set of multiple synchronization raster frequencies. The operations of 1810 may be performed in accordance with examples as disclosed herein. In some examples, aspects of the operations of 1810 may be performed by a subpanel configuration manager 1235 as described with reference to FIG. 12.

At 1815, the method may include receiving an uplink signal from the UE indicating a raster index corresponding to one of the respective synchronization raster frequencies from the first subset or the second subset of the set of multiple synchronization raster frequencies. The operations of 1815 may be performed in accordance with examples as disclosed herein. In some examples, aspects of the operations of 1815 may be performed by a raster index manager 1230 as described with reference to FIG. 12.

The following provides an overview of aspects of the present disclosure:
Aspect 1: A method for wireless communication at a UE, comprising: monitoring a plurality of synchronization raster frequencies to identify a frequency of a downlink signal transmitted from a base station, a first subset of the plurality of synchronization raster frequencies corresponding to the UE receiving the downlink signal from the base station and a second subset of the plurality of synchronization raster frequencies corresponding to the UE receiving the downlink signal from the base station via a configurable reflective device; identifying a raster index associated with the frequency, the raster index corresponding to one of receiving the downlink signal from the base station or receiving the downlink signal from the base station via the configurable reflective device; and transmitting an uplink signal to the base station indicating the raster index.
Aspect 2: The method of aspect 1, further comprising: identifying a random access configuration corresponding to the raster index to use during a random access procedure with the base station; and transmitting one or more random access messages according to the random access configuration.
Aspect 3: The method of aspect 2, wherein transmitting the one or more random access messages further comprises: transmitting the one or more random access messages during a random access occasion selected from a plurality of available random access occasions, wherein the random access configuration indicates the random access occasion corresponding to the raster index.
Aspect 4: The method of any of aspects 2 through 3, wherein transmitting the one or more random access messages further comprises: transmitting the one or more random access messages comprising a random access preamble selected from a plurality of available random access preambles, wherein the random access configuration indicates the random access preamble corresponding to the raster index.
Aspect 5: The method of any of aspects 1 through 4, further comprising: transmitting, based at least in part on the monitoring, the uplink signal indicating the raster index in a frequency domain and a beam index in a time domain corresponding to the downlink signal.
Aspect 6: The method of any of aspects 1 through 5, further comprising: identifying a beam index associated with the downlink signal transmitted from the base station, wherein the beam index is based at least in part on the raster index and the uplink signal indicates the beam index.
Aspect 7: The method of any of aspects 1 through 6, wherein the first subset of the plurality of synchronization raster frequencies are associated with a network configured synchronization raster and the second subset of the plurality of synchronization raster frequencies comprise offset frequencies relative to a default network configured synchronization raster.
Aspect 8: A method for wireless communication at a base station, comprising: transmitting a downlink signal to a UE via a first frequency of a first subset of a plurality of synchronization raster frequencies; receiving an uplink signal from the UE indicating a raster index, the raster index associated with a frequency of the downlink signal identified by the UE, the raster index corresponding to the UE one of receiving the downlink signal from the base station via the first frequency or receiving the downlink signal from the base station via a second frequency of a second subset of the plurality of synchronization raster frequencies corresponding to the UE receiving the downlink signal from the base station via a configurable reflective device; and communicating with the UE based at least in part on the raster index indicated in the uplink signal.
Aspect 9: The method of aspect 8, further comprising: identifying, based at least in part on the raster index, a configurable subpanel of a set of configurable subpanels of the configurable reflective device used to reflect the downlink signal from the base station to the UE.
Aspect 10: The method of aspect 9, wherein each configurable subpanel of the set of configurable subpanels is associated with a respective frequency and each frequency of the respective frequencies is associated with a respective raster index.
Aspect 11: The method of any of aspects 8 through 10, further comprising: receiving one or more random access messages from the UE according to a random access configuration, the random access configuration corresponding to the raster index.
Aspect 12: The method of aspect 11, wherein receiving the one or more random access messages further comprises: receiving the one or more random access messages during a random access occasion selected from a plurality of available random access occasions, wherein the random access configuration indicates the random access occasion corresponding to the raster index.
Aspect 13: The method of any of aspects 11 through 12, wherein receiving the one or more random access messages further comprises: receiving the one or more random access messages comprising a random access preamble selected from a plurality of available random access preambles, wherein the random access configuration indicates the random access preamble corresponding to the raster index.
Aspect 14: The method of any of aspects 8 through 13, further comprising: receiving the uplink signal indicating the raster index in a frequency domain and a beam index in a time domain corresponding to the downlink signal.
Aspect 15: The method of any of aspects 8 through 14, further comprising: identifying, based at least in part on the raster index, a beam index associated with the downlink signal, wherein the beam index corresponds to the raster index and the uplink signal indicates the beam index.
Aspect 16: The method of any of aspects 8 through 15, wherein the raster index associated with the frequency is from a synchronization raster associated with the configurable reflective device and the synchronization raster comprises a set of raster indices that are based at least in part on a number of configurable subpanels of the configurable reflective device.
Aspect 17: A method for wireless communication at a configurable reflective device, comprising: receiving, from a base station, a downlink signal at a frequency from a first subset of a plurality of synchronization raster frequencies; receiving, from the base station, control signaling indicating to configure each configurable subpanel of a set of configurable subpanels of the configurable reflective device to reflect the downlink signal to a UE at a respective synchronization raster frequency from a second subset of the plurality of synchronization raster frequencies; and receiving an uplink signal from the UE indicating a raster index corresponding to one of the respective synchronization raster frequencies from the first subset or the second subset of the plurality of synchronization raster frequencies.
Aspect 18: The method of aspect 17, further comprising: reflecting the uplink signal from the UE to the base station via at least one configurable subpanel of the set of configurable subpanels.
Aspect 19: An apparatus for wireless communication at a UE, comprising a processor; memory coupled with the processor; and instructions stored in the memory and executable by the processor to cause the apparatus to perform a method of any of aspects 1 through 7.
Aspect 20: An apparatus for wireless communication at a UE, comprising at least one means for performing a method of any of aspects 1 through 7.
Aspect 21: A non-transitory computer-readable medium storing code for wireless communication at a UE, the code comprising instructions executable by a processor to perform a method of any of aspects 1 through 7.
Aspect 22: An apparatus for wireless communication at a base station, comprising a processor; memory coupled with the processor; and instructions stored in the memory and executable by the processor to cause the apparatus to perform a method of any of aspects 8 through 16.
Aspect 23: An apparatus for wireless communication at a base station, comprising at least one means for performing a method of any of aspects 8 through 16.
Aspect 24: A non-transitory computer-readable medium storing code for wireless communication at a base station, the code comprising instructions executable by a processor to perform a method of any of aspects 8 through 16.
Aspect 25: An apparatus for wireless communication at a configurable reflective device, comprising a processor; memory coupled with the processor; and instructions stored in the memory and executable by the processor to cause the apparatus to perform a method of any of aspects 17 through 18.
Aspect 26: An apparatus for wireless communication at a configurable reflective device, comprising at least one means for performing a method of any of aspects 17 through 18.
Aspect 27: A non-transitory computer-readable medium storing code for wireless communication at a configurable reflective device, the code comprising instructions executable by a processor to perform a method of any of aspects 17 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a memory; and
a processor coupled to the memory and configured to:
monitor a plurality of synchronization raster frequencies to identify a frequency of a downlink signal transmitted from a base station, a first subset of the plurality of synchronization raster frequencies corresponding to the UE receiving the downlink signal from the base station and a second subset of the plurality of synchronization raster frequencies corresponding to the UE receiving the downlink signal from the base station via a configurable reflective device;
identify a raster index associated with the frequency, the raster index corresponding to one of receiving the downlink signal from the base station or receiving the downlink signal from the base station via the configurable reflective device; and
transmit an uplink signal to the base station indicating the raster index.

2. The apparatus of claim 1, wherein the processor coupled to the memory are further configured to:
identify a random access configuration corresponding to the raster index to use during a random access procedure with the base station; and
transmit one or more random access messages according to the random access configuration.

3. The apparatus of claim 2, wherein the processor coupled to the memory configured to transmit the one or more random access messages are further configured to:
transmit the one or more random access messages during a random access occasion selected from a plurality of available random access occasions, wherein the random access configuration indicates the random access occasion corresponding to the raster index.

4. The apparatus of claim 2, wherein the processor coupled to the memory configured to transmit the one or more random access messages are further configured to:
transmit the one or more random access messages comprising a random access preamble selected from a plurality of available random access preambles, wherein the random access configuration indicates the random access preamble corresponding to the raster index.

5. The apparatus of claim 1, wherein the processor coupled to the memory are further configured to:
transmit, based at least in part on the monitoring, the uplink signal indicating the raster index in a frequency domain and a beam index in a time domain corresponding to the downlink signal.

6. The apparatus of claim 1, wherein the processor coupled to the memory are further configured to:
identify a beam index associated with the downlink signal transmitted from the base station, wherein the beam index is based at least in part on the raster index and the uplink signal indicates the beam index.

7. The apparatus of claim 1, wherein the first subset of the plurality of synchronization raster frequencies are associated with a network configured synchronization raster and the second subset of the plurality of synchronization raster frequencies comprise offset frequencies relative to a default network configured synchronization raster.

8. An apparatus for wireless communication at a base station, comprising:
a memory; and
a processor coupled to the memory and configured to:
transmit a downlink signal to a user equipment (UE) via a first frequency of a first subset of a plurality of synchronization raster frequencies;
receive an uplink signal from the UE indicating a raster index, the raster index associated with a frequency of the downlink signal identified by the UE, the raster index corresponding to the UE one of receiving the downlink signal from the base station via the first frequency or receiving the downlink signal from the base station via a second frequency of a second subset of the plurality of synchronization raster frequencies corresponding to the UE receiving the downlink signal from the base station via a configurable reflective device; and
communicate with the UE based at least in part on the raster index indicated in the uplink signal.

9. The apparatus of claim 8, wherein the processor coupled to the memory are further configured to:
identify, based at least in part on the raster index, a configurable subpanel of a set of configurable subpanels of the configurable reflective device used to reflect the downlink signal from the base station to the UE.

10. The apparatus of claim 9, wherein each configurable subpanel of the set of configurable subpanels is associated with a respective frequency and each frequency of the respective frequencies is associated with a respective raster index.

11. The apparatus of claim 8, wherein the processor coupled to the memory are further configured to:
receive one or more random access messages from the UE according to a random access configuration, the random access configuration corresponding to the raster index.

12. The apparatus of claim 11, wherein the processor coupled to the memory configured to receive the one or more random access messages are further configured to:
receive the one or more random access messages during a random access occasion selected from a plurality of available random access occasions, wherein the random access configuration indicates the random access occasion corresponding to the raster index.

13. The apparatus of claim 11, wherein the processor coupled to the memory configured to receive the one or more random access messages are further configured to:
receive the one or more random access messages comprising a random access preamble selected from a plurality of available random access preambles, wherein the random access configuration indicates the random access preamble corresponding to the raster index.

14. The apparatus of claim 8, wherein the processor coupled to the memory are further configured to:
receive the uplink signal indicating the raster index in a frequency domain and a beam index in a time domain corresponding to the downlink signal.

15. The apparatus of claim 8, wherein the processor coupled to the memory are further configured to:
identify, based at least in part on the raster index, a beam index associated with the downlink signal, wherein the beam index corresponds to the raster index and the uplink signal indicates the beam index.

16. The apparatus of claim 8, wherein the raster index associated with the frequency is from a synchronization raster associated with the configurable reflective device and the synchronization raster comprises a set of raster indices that are based at least in part on a number of configurable subpanels of the configurable reflective device.

17. An apparatus for wireless communication at a configurable reflective device, comprising:
a memory; and
a processor coupled to the memory and configured to:
receive, from a base station, a downlink signal at a frequency from a first subset of a plurality of synchronization raster frequencies;
receive, from the base station, control signaling indicating to configure each configurable subpanel of a set of configurable subpanels of the configurable reflective device to reflect the downlink signal to a user equipment (UE) at a respective synchronization raster frequency from a second subset of the plurality of synchronization raster frequencies; and
receive an uplink signal from the UE indicating a raster index corresponding to one of the respective synchronization raster frequencies from the first subset or the second subset of the plurality of synchronization raster frequencies.

18. The apparatus of claim 17, wherein processer coupled to the memory are further configured to:
reflect the uplink signal from the UE to the base station via at least one configurable subpanel of the set of configurable subpanels.

19. A method for wireless communication at a user equipment (UE), comprising:
monitoring a plurality of synchronization raster frequencies to identify a frequency of a downlink signal transmitted from a base station, a first subset of the plurality of synchronization raster frequencies corresponding to the UE receiving the downlink signal from the base station and a second subset of the plurality of synchronization raster frequencies corresponding to the UE receiving the downlink signal from the base station via a configurable reflective device;
identifying a raster index associated with the frequency, the raster index corresponding to one of receiving the downlink signal from the base station or receiving the downlink signal from the base station via the configurable reflective device; and
transmitting an uplink signal to the base station indicating the raster index.

20. The method of claim 19, further comprising:
identifying a random access configuration corresponding to the raster index to use during a random access procedure with the base station; and
transmitting one or more random access messages according to the random access configuration.

21. The method of claim 20, wherein transmitting the one or more random access messages further comprises:
transmitting the one or more random access messages during a random access occasion selected from a plurality of available random access occasions, wherein the random access configuration indicates the random access occasion corresponding to the raster index.

22. The method of claim 20, wherein transmitting the one or more random access messages further comprises:
transmitting the one or more random access messages comprising a random access preamble selected from a plurality of available random access preambles, wherein the random access configuration indicates the random access preamble corresponding to the raster index.

23. The method of claim 19, further comprising:
transmitting, based at least in part on the monitoring, the uplink signal indicating the raster index in a frequency domain and a beam index in a time domain corresponding to the downlink signal.

24. The method of claim 19, further comprising:
identifying a beam index associated with the downlink signal transmitted from the base station, wherein the beam index is based at least in part on the raster index and the uplink signal indicates the beam index.

25. The method of claim 19, wherein the first subset of the plurality of synchronization raster frequencies are associated with a network configured synchronization raster and the second subset of the plurality of synchronization raster frequencies comprise offset frequencies relative to a default network configured synchronization raster.
